(19) United States
(12) Patent Application Publication
(10) Pub. No.: US 2026/0362394 A1
(43) Pub. Date: Nov. 12, 2026

(54) FREQUENCY SELECTION IN A HORIZONTAL DIRECTIONAL DRILLING SYSTEM USING ARTIFICIAL INTELLIGENCE

(71) Applicant: Merlin Technology, Inc., Kent, WA (US)

(72) Inventors: Daniel J. Bahr, Tacoma, WA (US); Thomas J. Hall, Newcastle, WA (US)

(21) Appl. No.: 19/201,348

(22) Filed: May 7, 2025

(51) Int. Cl. H04W 72/02; H04B 17/309; H04L 41/16; H04W 72/0453; H04W 72/54

(52) U.S. Cl. CPC H04W 72/02; H04B 17/346; H04L 41/16; H04W 72/0453; H04W 72/54

(57) ABSTRACT

Frequency selection using artificial intelligence is customized for use in a system for performing horizontal directional drilling. A portable device captures ambient noise data to form a dataset that is of unknown time duration and size until the noise capture is complete. The dataset can directly represent the ambient noise data or be converted to a predicted depth form. Once the capture is complete, an image is formed from a fixed size dataset and analyzed by one or more AI models that are trained on a plurality of datasets of historical noise data to select one or more frequencies or frequency bands. An AI model can be directed to identifying regions in an original noise dataset that exhibits a particular noise feature such that different frequencies can subsequently be selected from one region to the next.

### BACKGROUND

The present application is generally related to the field of horizontal directional drilling and, more particularly, to an advanced frequency selection system, apparatus and methods using artificial intelligence.

A technique that is often referred to as horizontal directional drilling (HDD) can be used for purposes of installing a utility without the need to dig a trench. A typical utility installation involves the use of a drill rig having a drill string that supports a boring tool at a distal or inground end of the drill string. The drill rig forces the boring tool through the ground by applying a thrust force to the drill string. The boring tool is steered during the extension of the drill string to form a pilot bore. Upon completion of the pilot bore, the distal end of the drill string is attached to a pullback apparatus which is, in turn, attached to a leading end of the utility. The pullback apparatus and utility are then pulled through the pilot bore via retraction of the drill string to complete the installation. In some cases, the pullback apparatus can comprise a back reaming tool which serves to expand the diameter of the pilot bore ahead of the utility so that the installed utility can be of a greater diameter than the original diameter of the pilot bore.

Steering of a boring tool can be accomplished in a well-known manner by orienting an asymmetric face of the boring tool for deflection in a desired direction in the ground responsive to forward movement. In order to control this steering, it is desirable to monitor the orientation of the boring tool based on sensor readings obtained by sensors that form part of an electronics package that is supported by the boring tool. The sensor readings, for example, can be modulated onto an electromagnetic locating signal that is transmitted by the electronics package through the ground via an antenna for reception above ground by a portable locator or other suitable above ground device. For a given amount of transmission power, there is a limited transmission range at which the sensor data can be recovered with sufficient accuracy. The transmission range can be further limited by active interference. Active interference generally consists of electromagnetic noise present in the operational region that can vary based on location and overwhelm the locating signal being transmitted by the system. In the past, the selection of a frequency to utilize for the locating signal was little more than guesswork. In response to the then-existing deficiencies of the prior art, Applicant filed commonly owned U.S. Pat. No. 8,729,901 (hereinafter the '901 Patent), entitled MEASUREMENT DEVICE AND ASSOCIATED METHOD FOR USE IN FREQUENCY SELECTION FOR INGROUND TRANSMISSION, U.S. Pat. No. 9,739,140 (hereinafter the '140 Patent), entitled COMMUNICATION PROTOCOL IN DIRECTIONAL DRILLING SYSTEM, APPARATUS AND METHOD UTILIZING MULTI-BIT DATA SYMBOL TRANSMISSION, and U.S. Pat. No. 10,378,338 (hereinafter the '338 Patent), entitled ADVANCED PASSIVE INTERFERENCE MANAGEMENT IN DIRECTIONAL DRILLING SYSTEM, APPARATUS AND METHODS, all of which are hereby incorporated by reference in their entireties and which may be referred to collectively as the Digital Control Patents. The Digital Control Patents are submitted to provide sweeping benefits over the then-existing state-of-the-art and continue to provide such improvements in terms of informing frequency selection for inground operations, however, the present Application brings to light still further advances and improvements, as will be discussed in detail at appropriate points hereinafter.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one aspect of the disclosure, embodiments of a portable device and associated methods are described for use in conjunction with a transmitter that is moved through the ground at a jobsite while transmitting at one or more frequencies, the jobsite including electromagnetic noise that can vary across the jobsite and within a transmission frequency range associated with the transmitter. In an embodiment, the portable device includes a noise detector for receiving electromagnetic noise data at the jobsite in an absence of transmission of the one or more frequencies from the transmitter. A processing arrangement is configured for (i) capturing the electromagnetic noise data from the noise detector to form a noise dataset that characterizes the electromagnetic noise data such that the noise dataset increases in size with ongoing capture of the electromagnetic noise data, (ii) responsive to ending the capture of the noise dataset such that the noise dataset covers a fixed time duration, preprocessing the captured electromagnetic noise data to represent the captured electromagnetic noise data as an image that conforms to a set of predetermined input requirements of a frequency selection Artificial Intelligence (AI) model, and (iii) analyzing the image using the frequency selection AI model that is trained on a plurality of datasets of historical noise data to select the one or more frequencies within the transmission frequency range for subsequent use by the transmitter during an inground operation.

In another aspect of the disclosure, embodiments of a portable device and associated methods are described for use in conjunction with a transmitter that is moved through the ground at a jobsite while transmitting at one or more frequencies, the jobsite including electromagnetic noise that can vary across the jobsite and within a transmission frequency range associated with the transmitter. The portable device includes a noise detector for receiving electromagnetic noise data at the jobsite in an absence of transmission of the one or more frequencies from the transmitter. A processing arrangement is configured for (i) capturing the electromagnetic noise data as a series of data segments such that each data segment conforms to a set of predetermined input requirements of a frequency selection Artificial Intelligence (AI) model, (ii) analyzing each data segment using the frequency selection AI model that is trained on a plurality of data sets of historical noise data to determine a preliminary selection of the one or more frequencies within the transmission frequency range for each data segment such that a series of preliminary selections of the one or more frequencies corresponds to the series of data segments, and (iii) based on the series of preliminary selections of the one or more frequencies, finalizing the one or more frequencies for transmission by the transmitter during an inground operation. In one feature, the processing arrangement is configured to finalize the one or more frequencies by applying rankings to the one or more frequencies on a per segment basis and comparing the rankings to determine finalized frequency selections. In another feature, the processing arrangement is configured to discard any final data segment at the conclusion of capturing the electromagnetic noise data that does not conform to a predetermined time dimension as part of the set of predetermined input requirements.

In still another aspect of the disclosure, embodiments of a portable device and associated methods are described for use in conjunction with a transmitter that is moved through the ground at a jobsite while transmitting at one or more frequencies, the jobsite including electromagnetic noise that can vary across the jobsite and within a transmission frequency range associated with the transmitter. The portable device includes a noise detector for receiving original electromagnetic noise data at the jobsite in an absence of transmission of the one or more frequencies from the transmitter. A processing arrangement is configured for (i) capturing the electromagnetic noise data from the noise detector to form a noise dataset that characterizes the electromagnetic noise data such that the noise dataset increases in size with ongoing capture of the electromagnetic noise data, (ii) responsive to ending the capture of the noise dataset such that the noise dataset covers a fixed time duration, preprocessing the captured electromagnetic noise data to represent the captured electromagnetic noise data as an image that conforms to a set of predetermined input requirements of a frequency band selection Artificial Intelligence (AI) model, and (iii) analyzing the image using the frequency band selection AI model that is trained on a plurality of data sets of historical noise data to select at least one or more low noise bands within the transmission frequency range for subsequent use by the transmitter to transmit the one or more frequencies within the one or more selected low noise bands during an inground operation.

In an additional aspect of the disclosure, embodiments of a portable device and associated methods are described for use in conjunction with a transmitter that is moved through the ground at a jobsite while transmitting at one or more frequencies, the jobsite including electromagnetic noise that can vary across the jobsite and within a transmission frequency range associated with the transmitter. The portable device includes a noise detector for receiving electromagnetic noise data at the jobsite in an absence of transmission of the one or more frequencies from the transmitter. A processing arrangement is configured for (i) capturing the electromagnetic noise data from the noise detector to form a noise dataset that characterizes the electromagnetic noise data such that the noise dataset increases in size with ongoing capture of the electromagnetic noise data, (ii) responsive to ending the capture of the noise dataset such that the noise dataset covers a fixed time duration, preprocessing the captured electromagnetic noise data to represent the captured electromagnetic noise data as a predicted depth map that conforms to a set of predetermined input requirements of a frequency selection Artificial Intelligence (AI) model and (iii) analyzing the predicted depth map using a frequency selection AI model that is trained on a plurality of data sets of historical predicted depth data to select the one or more frequencies within the transmission frequency range for subsequent use by the transmitter during an inground operation.

In yet another aspect of the disclosure, embodiments of a portable device and associated methods are described for use in conjunction with a transmitter that is moved through the ground at a jobsite while transmitting at one or more selectable frequencies, the jobsite including electromagnetic noise that can vary across the jobsite and within a transmission frequency range associated with the transmitter. The portable device includes a noise detector for receiving electromagnetic noise data at the jobsite in an absence of transmission of the one or more selectable frequencies from the transmitter. A processing arrangement is configured for (i) capturing the electromagnetic noise data from the noise detector to form a noise dataset that characterizes the electromagnetic noise data such that the noise dataset increases in size with ongoing capture of the electromagnetic noise data, (ii) responsive to ending the capture of the noise dataset such that the noise dataset covers a fixed time duration, the captured electromagnetic noise data is preprocessed to represent the captured electromagnetic noise data as an image that conforms to a set of predetermined input requirements of a region identification Artificial Intelligence (AI) model, and (iii) analyzing the image using the region identification AI model that is trained on a plurality of data sets of region specific historical electromagnetic noise data to identify a first border between an initial, first region of the electromagnetic noise data and a remaining portion of the electromagnetic noise data such that the first region exhibits a common noise feature that is not shared with at least an initial part of the remaining portion of the electromagnetic noise data and the first region corresponds to a first portion of the electromagnetic noise data.

### BRIEF DESCRIPTIONS OF THE DRAWINGS

Example embodiments are illustrated in referenced figures of the drawings. It is intended that the embodiments and figures disclosed herein are to be illustrative rather than limiting.

FIG. 1 is a diagrammatic view, in partial perspective, illustrating an embodiment of a system for performing an inground operation in accordance with the present disclosure.

FIG. 2 is a block diagram that illustrates one embodiment of a portable device in accordance with the present disclosure.

FIG. 3 is a diagrammatic, partially cutaway view, in perspective, illustrating an embodiment of the transmitter shown in FIG. 1.

FIG. 4 is a diagrammatic illustration of a noise dataset undergoing collection by a portable device in accordance with the present disclosure.

FIG. 5 is a flow diagram illustrating one embodiment of a method for performing noise scanning and data collection in accordance with the present disclosure.

FIG. 6 is a flow diagram illustrating one embodiment of a method for preprocessing an original noise dataset for subsequent use in accordance with the present disclosure.

FIG. 7 is a block diagram illustrating one embodiment of the architecture of an Artificial Intelligence model that is suitable for selecting frequencies or bands as well as region identification in accordance with the present disclosure.

FIG. 8 is a flow diagram illustrating an embodiment of a method for region identification in accordance with the present disclosure.

FIGS. 9a-9e are spectrographic representations of regions initially seen in FIG. 4 in vertical alignment and shown here to graphically illustrate an overall region splitting method in accordance with the present disclosure.

FIG. 10 is a flow diagram illustrating one embodiment of a method for operating the portable device of the present disclosure for frequency selection purposes.

FIG. 11 illustrates one embodiment of a screen shot that can be presented on the portable device for frequency selection purposes in accordance with the present disclosure.

FIG. 12 taken in conjunction with FIGS. 14 and 15 are flow diagrams illustrating an embodiment of a method for frequency band selection in accordance with the present disclosure.

FIG. 13 is an embodiment of a screenshot that can be presented on the portable device for purposes of facilitating frequency band selection in accordance with the present disclosure.

FIG. 16 is a block diagram illustrating an embodiment of an AI training system in accordance with the present disclosure.

FIG. 17 is a flow diagram illustrating an embodiment of a method for operating the AI training system of FIG. 16.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiment shown, but is to be accorded the widest scope consistent with the principles and features described herein including modifications and equivalents. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

Some prior art locating systems allow for selection of a frequency or frequencies to avoid as much electromagnetic noise as possible (which essentially results in a higher possible reception range or depth), and provide for measuring the electromagnetic noise at one or more frequencies and generating either a noise value or a predicted maximum drilling (transmission) depth to assist the user with selection of a frequency or frequencies. The present application brings to light a frequency selection process and apparatus that reduces operator workload while providing for the selection of the most optimal frequency or frequencies and/or frequency bands for a given locating system.

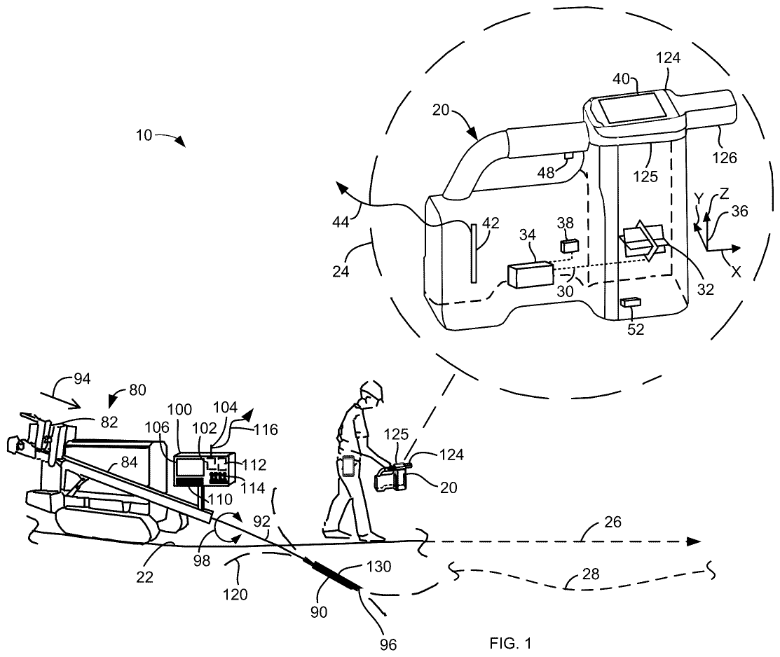

Turning now to the drawings, wherein like items may be indicated by like reference numbers throughout the various figures, attention is immediately directed to FIG. 1, which illustrates one embodiment of a system for performing an inground operation, generally indicated by the reference number 10. The system includes a portable device 20 that is shown being held by an operator above a surface 22 of the ground as well as in a further enlarged inset view within a dashed circle 24 such that the operator can move the portable device along an intended path 26 which is illustrated as a dashed line at the surface of the ground that is generally directly above a bore plan 28. As shown, the bore plan can include a variable depth to avoid underground obstacles such as, for example, previously installed utility lines.

Still referring to FIG. 1, it is noted that only limited inter-component cabling 30 is shown within device 20 using dotted lines in order to maintain illustrative clarity, but all necessary cabling is understood to be present and may readily be implemented by one having ordinary skill in the art in view of this overall disclosure. Device 20 includes a suitable three-axis antenna cluster 32 measuring three orthogonally arranged components of magnetic flux. One embodiment of a useful antenna cluster contemplated for use herein is disclosed by U.S. Pat. No. 6,005,532 which is commonly owned with the present application. Antenna cluster 32 is electrically connected to an electronics section 34 to measure electromagnetic signals in a triaxial coordinate system 36. A tilt sensor arrangement 38 can be provided for measuring gravitational angles from which the components of flux in a level coordinate system may be determined as well as the orientation of the portable device. An appropriate tilt sensor includes, by way of non-limiting example, a triaxial accelerometer.

Device 20 can further include a graphics display 40 and a telemetry antenna 42. The latter can transmit or receive a telemetry signal 44 for data communication with the drill rig. It should be appreciated that graphics display 40 can be a touch screen in order to facilitate operator selection of various buttons that are defined on the screen and/or scrolling can be facilitated between various buttons that are defined on the screen to provide for operator selection. Such a touch screen can be used alone or in combination with an input device 48 such as, for example, a trigger button. The latter can be used without the need for a touch screen. Moreover, many variations of the input device may be employed and can use scroll wheels and other suitable forms of selection device either currently available or yet to be developed. The electronics section can include components such as, for example, a memory of any appropriate type, one or more processors, antenna drivers and analog to digital converters (ADCs). As is well known in the art, the ADCs should be capable of detecting a frequency that is at least twice the frequency of the highest frequency of interest. Other components may be added as desired such as, for example, a magnetometer 52 to aid in position determination relative to the drill direction and ultrasonic transducers for measuring the height of the device above the surface of the ground. In some embodiments, an inertia measurement unit (IMU) can be used in place of or in addition to magnetometer 52.

Still referring to FIG. 1, system 10 further includes drill rig 80 having a carriage 82 received for movement along the length of an opposing pair of rails 84. An inground tool 90 is attached at an opposing end of a drill string 92. By way of non-limiting example, a boring tool is shown as the inground tool and is used as a framework for the present descriptions, however, it is to be understood that any suitable inground device may be used such as, for example, a reaming tool for use during a pullback operation or a mapping tool. Generally, drill string 92 is made up of a plurality of removably attachable drill pipe sections such that the drill rig can force the drill string into the ground using movement in the direction of an arrow 94 and retract the drill string responsive to an opposite movement. The drill pipe sections can define a through passage for purposes of carrying a drilling mud or fluid that is emitted from the boring tool under pressure to assist in cutting through the ground as well as cooling the drill head. Generally, the drilling mud also serves to suspend and carry out cuttings to the surface along the exterior length of the drill string. Steering can be accomplished in a well-known manner by orienting an asymmetric face 96 of the boring tool for deflection in a desired direction in the ground responsive to forward, push movement which can be referred to as a “push mode.” Rotation or spinning 98 of the drill string by the drill rig will generally result in forward or straight advance of the boring tool which can be referred to as a “spin” or “advance” mode.

The drilling operation can be controlled by an operator (not shown) at a control console 100 which itself includes a telemetry transceiver 102 connected with a telemetry antenna 104, a display screen 106, an input device such as a keyboard 110, a processing arrangement 112 which can include suitable interfaces and memory as well as one or more processors. A plurality of control levers 114, for example, control movement of carriage 82. Telemetry transceiver 104 can transmit or receive a telemetry signal 116 to facilitate bidirectional communication with portable device 20. In an embodiment, screen 106 can be a touch screen such that keyboard 110 may be optional.

In an embodiment, device 20 is configured for receiving one or more electromagnetic signals 120 that can include a depth signal for tracking or locating the inground tool and an electromagnetic data signal, both of which are transmitted from a transmitter 130 that is supported within a housing or within some other suitable inground tool. For drilling, the distal end of the housing can receive a drill bit while the uphole end of the housing can receive the distal, inground end of the drill string.

Device 20, in one embodiment, can further include GPS functionality with a GPS module and antenna integral to the overall device. In another embodiment, a GPS (Global Positioning System) unit 124 is removably attachable to the device by placing a frame 125 around the display head of the device such that display 36 remains visible. Electrical connections can be made with electronics section 34 on an interior periphery of frame 125. In this latter embodiment, an antenna arm 126 can support the GPS antenna to provide a more clear view of the sky as well as additional spatial isolation from electrical noise sources internal to device 20. One suitable GPS unit is described in commonly owned U.S. Pat. No. 11,067,700, entitled REMOVABLY ATTACHABLE GPS MODULE FOR A PORTABLE LOCATOR. In some embodiments configured with GPS, the GPS unit can be high precision so as to provide positional accuracy down to small distances such as, for example, 5 cm or less.

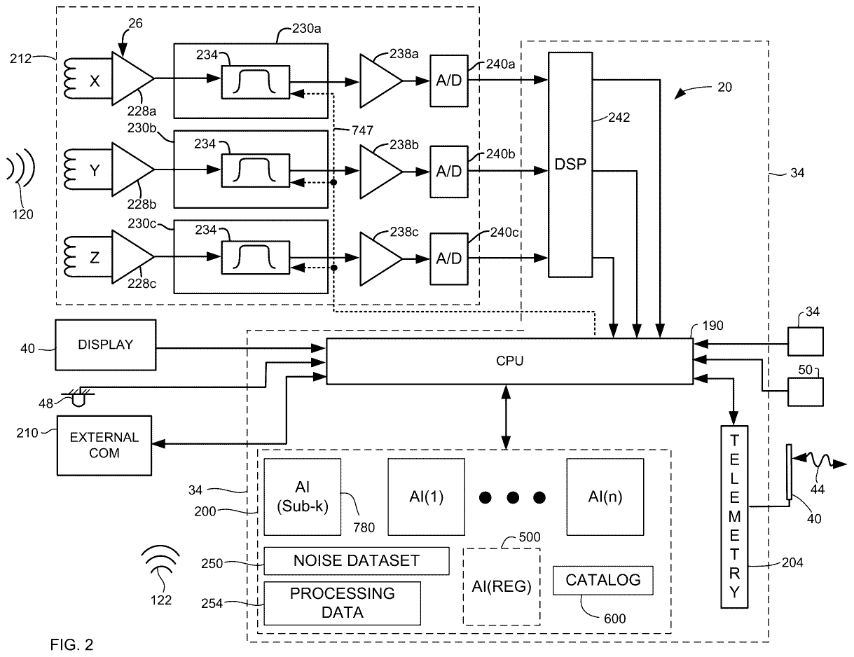

Attention is now directed to FIG. 2 in conjunction with FIG. 1 for purposes of describing additional details with respect to device 20 which may be referred to interchangeably as a locator or receiver. FIG. 2 is a block diagram that illustrates device 20. Electronics section 34 includes a processor 190 that is interfaced with a memory 200. A telemetry section 204 is controlled by the processor and coupled to antenna 40 for bidirectional communication via signal 44. In some embodiments, the telemetry link can be unidirectional from device 20 to the drill rig, in which case transceiver 204 need only include receiver functionality. An external communication arrangement 210 provides for external communication with a transmitter using an external communication connection of transmitter 130. Such communication is not required to be transmitted through the ground but rather can be performed while the transmitter is above ground, for example, in a position adjacent to device 20. The external communication can be implemented in any suitable manner including but not limited to IrDA, NFC, Wi-Fi, Zigbee or Bluetooth. A wide-band front end 212 can be referred to as a noise detector and can be configured for receiving transmitter signals 120 using X, Y and Z antennas which make up antenna cluster 26 for measuring three orthogonal components of the subject signals as well as for performing noise measurements along these axes, as is yet to be described. Each of the X, Y and Z antennas can be interfaced to a low noise amplifier (LNA) 228a, 228b and 228c, respectively, each of which can be identically configured. The amplified output of each LNA is supplied to a respective one of filter sections 230a, 230b and 230c, each of which can be configured identically and which may be referred to collectively as filter sections 230. Each filter section can include any suitable number of bandpass filters 234. In the present embodiment, a single wideband filter is shown, however, this is not intended as being limiting. By way of non-limiting example, each filter can be implemented as a series of RC high-pass and low-pass filters that are distributed throughout the signal chain. CPU 190 can control filter selections 234, for instance, in the case of programmable filters for normal and rebar modes. Amplifiers 238a-238c can follow each respective one of filters 234 with sufficient gain for purposes of driving each of analog-to-digital converters A/D 240a-240c. Each A/D 240 provides an output to CPU 190. Wideband front end 212 provides outputs to a Digital Signal Processor (DSP) 242 which is, in turn, interfaced to CPU 190. DSP 242 serves to sample the outputs from each antenna axis. Noise values can be determined in any suitable manner such as, for example, using a Fast Fourier Transform (FFT) to convert from the time domain to the frequency domain, thereby generating digital signal strength readings corresponding to the noise across a given frequency range based on the analog outputs of the antennas. It is noted that the sampling rate of the DSP should be at least double the highest frequency that is targeted for measurement. For example, if the highest frequency is 50 kHz, the sampling rate should be at least 100 kHz.

### Noise Measurement and Storage

Device 20 can be configured for performing noise measurements and analysis for purposes of frequency selection. Noise measurements can be determined based on each orthogonal axis of antenna 26 (X, Y and Z axes, FIG. 1). These individual noise components can be used to establish a three dimensional noise value, for example, based on a vector sum of the three antenna components or the components can be used individually. As will be further described, memory 200 includes a noise dataset 250 that is generated from the noise measurements and processing data 254 that can be derived from the noise dataset. The noise dataset can be thought of as characterizing an image such as, for example, a spectrogram, although there is no requirement to store the noise dataset or any datasets derived from the original noise dataset in the explicit form of an image or spectrogram. The noise data can be stored in memory in any suitable manner. Throughout the remainder of the disclosure and the appended claims, references to noise datasets may include, but do not require, the storage of an image or spectrogram. As will be brought to light herein, Applicant recognizes that frequency and frequency band selections can be made in a heretofore unseen and advanced manner in the field of horizontal directional drilling by converting stored noise data to an image format that leverages the strengths of artificial intelligence models or by storing the noise data in such an image format in the first instance.

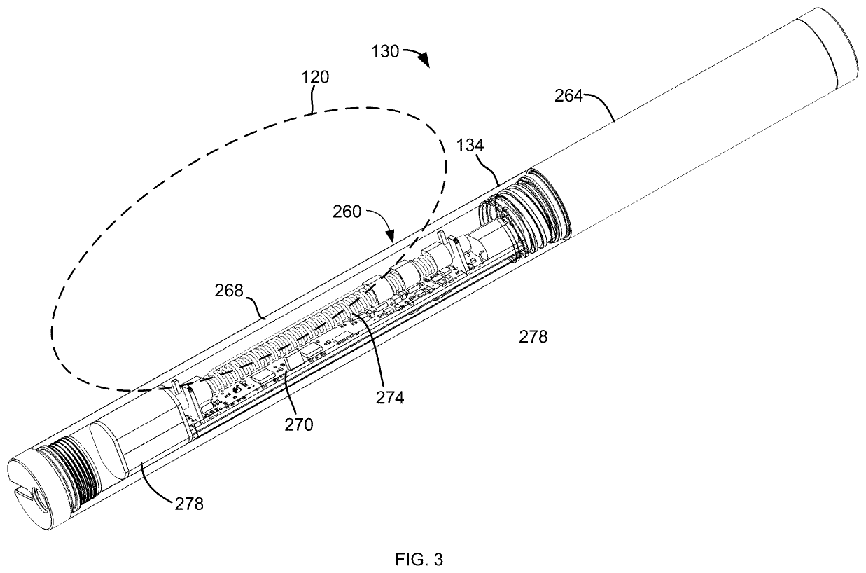

FIG. 3 is a diagrammatic, partially cutaway view, in perspective, which illustrates an embodiment of transmitter 130 by way of non-limiting example. The latter includes a main housing 260 that can be at least generally cylindrical in configuration. A battery compartment 264 can be formed at one end of the housing with an opposing end 268 supporting a main printed circuit board (PCB) 270 which itself can support an antenna 274 that emits the electromagnetic transmitter signal(s). An accelerometer module 278 can be positioned adjacent to one end of PCB 270. Other sensors and components can be located on the main printed circuit board. Electromagnetic signals 120 may be referred to collectively herein as the transmitter signals. In some embodiments, one electromagnetic signal can be transmitted as a dipole locating signal having a modulated carrier wave to carry data and for locating the inground tool. In other embodiments, a depth signal can be transmitted as an unmodulated carrier wave or pure frequency for locating purposes and another data signal can be transmitted using a modulated carrier. In still other embodiments, data signals can comprise a plurality of symbol frequencies to transfer data such that each symbol represents a multi-bit value transmitted at a unique frequency. Information carried by the data signal(s) or by a modulated locating signal can include, but is not limited to position orientation parameters based on pitch and roll orientation sensor readings, temperature values, pressure values, battery status, tension readings in the context of a pullback operation and the like. As another non-limiting example of a suitable transmitter design, the reader is referred to commonly owned U.S. patent application Ser. No. 18/939,276 filed on Nov. 6, 2024, entitled HORIZONTAL DIRECTIONAL DRILLING SONDE WITH ADVANCED MAGNETIC CORE TECHNOLOGY AND ASSOCIATED METHODS. It should be appreciated that the portable device can be operated in either a walkover locating mode, as illustrated by FIG. 1, or in a homing mode with the portable device placed on the ground, for example, as illustrated by commonly owned U.S. Pat. No. 9,540,879 which is incorporated by reference in its entirety. While the present disclosure illustrates a dipole locating field transmitted from the boring tool and rotated about the axis of symmetry of the field, the present disclosure is not intended as being limiting in that regard. Device 20 receives the transmitter signals using antenna array 32 and processes the signal(s) to recover the data, as will be further described.

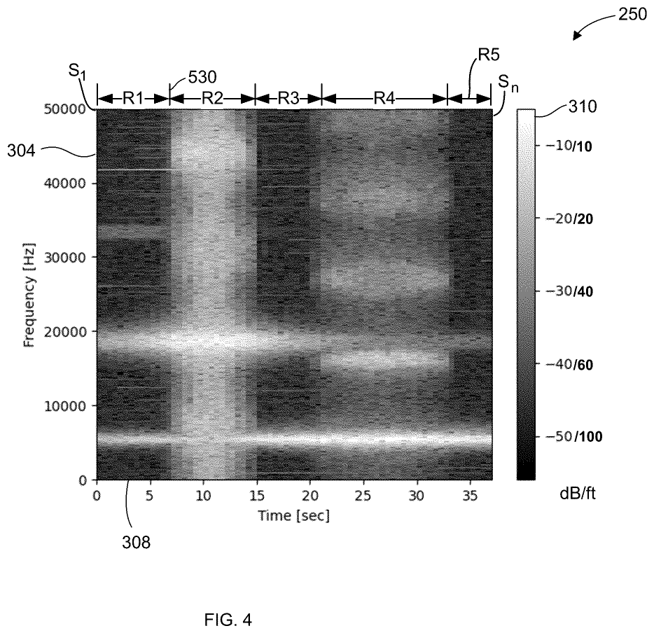

Attention is now directed to FIG. 4 which is a diagrammatic illustration of a noise dataset 250 undergoing collection in accordance with the present disclosure. The noise dataset is shown in the form of a spectrogram for purposes of admitting to illustration in order to enhance the understanding of the reader. In essence, such a spectrogram is in the form of a grid or noise map that can be generated based on the stored noise dataset even if the noise dataset is not initially stored in the form of a spectrogram or map. A vertical axis 304 represents a frequency scale extending, for example, from 0 Hz to 50 kHz. An orthogonal, horizontal axis 308 represents a time at which the corresponding noise data was collected, shown in seconds. It is noted that the FFT can be configured in any suitable manner in terms of producing a desired frequency resolution on frequency axis 304. In some embodiments, the resolution along the frequency axis can be based on the frequency resolution of transmitter 130 that will be used. For example, if the transmitter is capable of transmitting at a frequency increment of 5 Hz, the frequency axis can include 10,000 values for a frequency range of 0 Hz to 50 kHz. For a sampling rate of 100 kHz, the FFT time increment is 10 microseconds which serves as a measurement interval. Using the example of a spectrogram or map, data can be appended to noise dataset 250 as vertical slices of a horizontally expanding spectrogram, for example, per time slices from Si to Sn where Sn represents the most recently added slice. It is noted that the time slices may be referred to interchangeably as time increments. Any suitable time duration can be used for a time slice such as, for example, one second. The duration of a time slice can be based on available processing power, but should be short enough that an operator cannot walk far enough to skip over a unique area of noise. On the other hand, the time slice should be sufficiently long to avoid what can be considered as instantaneous noise anomalies that are so short in duration as to be of little significance as well as limiting the overall amount of data collected to a practical amount. Generally, a relatively longer spectrogram results in better performance of the procedures yet to be described. Magnitude values of the determined noise are illustrated, by way of non-limiting example, in accordance with a grey scale key 310 indicating the determined noise values in dB with relatively darker shading representing relatively higher determined noise. It is noted that original noise dataset 250 can be considered as representing measured noise corresponding to one measurement axis or corresponding to three-dimensional noise such as, for example, a vector sum or average derived from all three axes. In one embodiment, three-dimensional data can be represented as red, green, and blue (RGB) channels of a color image, which is not shown due to illustrative constraints, but effectively represents a separate noise dataset corresponding to each antenna axis. It is noted that this may produce more accurate results if the ambient noise is highly directional. With the foregoing in mind, it should be appreciated that the ambient noise data collection process is not limited to producing a single noise dataset. For example, different noise datasets can be dedicated to different purposes with the noise data in each noise dataset representing noise values along the frequency dimension at different resolutions and/or addressing different frequency ranges. In such embodiments and by way of non-limiting example, multiple instantiations of DSP 242 (FIG. 2) can be used with each DSP dedicated to a different frequency range.

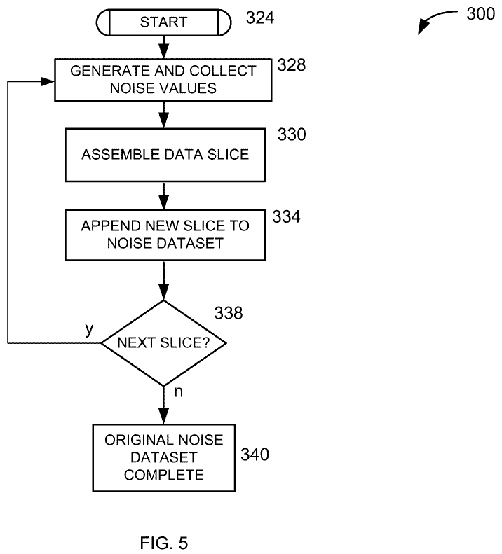

Turning now to FIG. 5, one embodiment of a method for producing original noise dataset 250 of FIG. 4 is generally indicated by the reference number 300 and begins at start 324. It is noted that other embodiments for performing noise scanning and data collection will be described at appropriate points hereinafter. A characteristic of many (though not all) horizontal directional drilling jobsites is that interference can change with relatively small changes in position. Therefore, a user should generally perform a sufficient amount of noise scanning and data collection to capture any changes in interference along the bore path, in order to identify an appropriate frequency or frequencies for transmission along the path that will avoid the most interference possible. Applicant has identified a challenge arising out of this, that simply feeding noise data into an AI model in real time may not be practical for many current AI models since it is important to know the time duration of the noise dataset so it may be scaled to the input requirements of the AI model.

In the present embodiment, the noise scanning can begin, for example, responsive to a user interaction with screen 40 (FIGS. 1 and 2). In order to accurately reflect the ambient noise environment, noise measurements should be made when transmitter 130 is not transmitting locating signal(s) 120. At 328, the ambient noise data can be captured from all three (X, Y and Z) axes simultaneously by processor 190 via DSP 242 and buffered, for example, in processing data section 254 of memory 200 (FIG. 2). The data from each axis can be collected separately and stored or the data from all three axes can be processed, for example, in accordance with the descriptions above before being saved to processing data section 254. At 330, a new slice Sn is assembled and can include the determined noise values as well as a time stamp indicating the time at which the noise measurements for the slice were taken. Under the condition that a GPS unit is provided and is generating a positional output, a GPS position of the portable device can be recorded for the current slice. Having assembled the current/new slice, the slice can be appended to the original noise dataset at 334. Step 338 queries whether another slice is to be added to the original noise dataset. This decision can be based, for example, on a user interaction with display screen 40 wherein the user can select a button that stops the collection of ambient noise data. If no such selection has been made, operation returns to step 328. On the other hand, if ambient noise data collection is complete, operation routes to 340 given that the original noise dataset is complete and available. In this regard, it should be appreciated that the original noise dataset expands in terms of its time duration so long as the noise capture process continues. Only when the noise capture ends is the original noise dataset in final form to exhibit a fixed and unchanging time duration, which is necessary for subsequent processing in the context of the present embodiment. In this regard, no restrictions on the final, fixed size of the original noise dataset are imposed a priori. In the example of FIG. 4, this expansion phenomenon would be seen as an extension or growth along the time axis as data slices are added. Applicant recognizes that this aspect of noise data collection renders most original noise datasets and corresponding images as incompatible with the input requirements of state-of-the-art AI models, yet to be described. As will be seen, Applicant has developed specialized preprocessing in order to address this problematic aspect of the original noise dataset in a flexible manner. It is noted that any noise dataset described herein can be considered as characterizing a grid or matrix of recorded values in the form, for example, of an image in an image format or a spectrogram. It should be appreciated that, during method 300, no restrictions are imposed on the operator in terms of movement. For example, the operator can walk the entire length of an intended bore path. As another example, the operator can walk a portion of an intended path. As still another example, the operator can stand stationary at one point along the intended bore path. As will be seen, the original noise dataset may be utilized repeatedly to produce a number of preprocessed or modified datasets in an image format or in the form of spectrograms relating to ongoing frequency selection objectives, yet to be described.

### Preprocessing

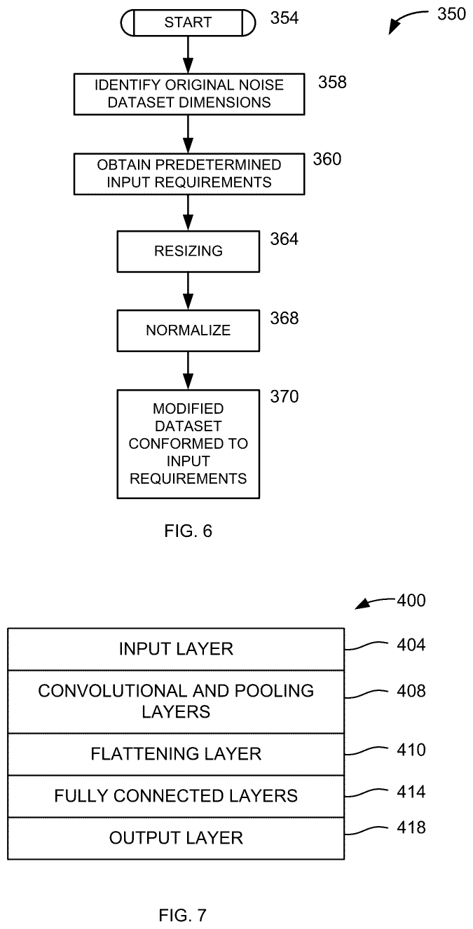

Referring to FIG. 6 and having original noise data 250 finalized and available, an embodiment of a method for preprocessing the original noise dataset for subsequent use is generally indicated by the reference number 350. At this juncture, it is noted that weighting can be applied to the data although this is not a requirement. The weighting can compensate for attributes of the measured electromagnetic noise including at least one of depth along a bore plan, location in which a specific position exhibits an enhanced level of ambient noise and duration in which a particular noise feature persists over a segment of an intended path. In terms of depth along a bore plan, ambient noise values can be increased relative to increasing depth. The method begins at start 354 and proceeds to 358 which can initially identify the dimensions of the original noise dataset. At 360, the original noise dataset can be compared to a set of predetermined input requirements that are specified as input parameters for the particular AI model that will receive an image based on the original noise dataset. It should be appreciated that the present embodiment is compatible with state-of-the-art AI model technology at least to the extent of exhibiting predetermined input requirements. The objective here is to produce an image from the original noise dataset that conforms to the predetermined input requirements along each of a frequency axis and a time axis. It is noted that a different handling is needed for the frequency axis as compared to the time axis. The need for specialized handling of the time axis arises as a result of the final duration of the time axis being unknown until the noise capture is complete. Thus, fitting the time axis of the original noise dataset to the required predetermined dimension along the time axis for a relevant AI model(s) is necessary. In many instances, the final time duration on the time axis of the original noise dataset is longer than the predetermined time axis dimension for the AI model(s), for example, when an operator performs the capture along an entire intended path. In some cases, however, the time axis of the original noise dataset can be shorter than the predetermined time axis dimension for the AI model(s), for example, if the operator performs a brief noise capture at one position to gain what is essentially a snapshot of the ambient noise at that position. Aspects of this fitting procedure will be described in detail below.

It is noted that the generated image can be stored in processing data section 254. As initially introduced above, the AI models employed herein generally require an input of predetermined size or dimensions along a frequency axis and a time axis which are referred to herein as this predetermined set of input requirements. The predetermined dimensions can correspond to a predetermined frequency resolution along vertical axis 304 shown in FIG. 4 and a predetermined time/distance resolution and length along horizontal axis 308. The predetermined input requirements can vary depending upon the intended purpose of the image. Aspects of preprocessing based on a number of intended purposes for the image will be discussed immediately hereinafter.

Referring to FIGS. 4 and 6 with respect to producing an image intended for frequency selection purposes, it is highly unlikely that the duration of the time axis of the original noise dataset will match the predetermined duration of the time axis specified by the predetermined set of input requirements for reasons that are discussed above. Accordingly, it is necessary to conform the time duration of the original noise dataset to the predetermined duration of the time axis specified by the input requirements for the relevant AI model(s) after the collection of the noise data has concluded. This resizing takes place at step 364 of FIG. 6. Of course, the time axis can also be indexed against GPS positions to characterize movement of the portable device, if any. The required predetermined input dimension along the time axis for purposes of frequency selection can be any suitable number of positions such as, for example, in a range from 30 seconds to 1000 seconds, although any suitable value can be used dependent upon available processing power. In the present example, a value of 128 positions is used by the AI frequency selection model(s). If it is assumed that the number of values along the length or duration of the time dimension of the original noise dataset is greater than the required predetermined time dimension, the original noise dataset can undergo what is essentially a shrinking process to get down to the number of positions required by the predetermined time dimension. By way of example, it is assumed that the predetermined time axis dimension is 128 positions or values in length, but the original noise dataset is 180 positions in length. Accordingly, it is necessary to adjust or shrink the time dimension by a factor of 1.4. This shrinking can be accomplished in any suitable manner, for example, as described below. On the other hand, it may be necessary to expand the original noise dataset to conform to the predetermined time dimension. For example, if the operator takes an ambient noise reading for 10 seconds, it is necessary to expand the time axis by a factor of 12.8. Details with respect to techniques for expanding and/or shrinking dimensions along the time axis will be discussed at an appropriate point hereinafter.

Resizing may also be necessary along the frequency axis to conform to the predetermined input requirements along the frequency axis, although this may not always be the case. In one embodiment, the noise values stored in the noise dataset can match the “native” predetermined dimension required by a frequency selection AI model on the frequency axis. For example, the predetermined input requirement along the frequency dimension can extend from 0 Hz to 50 kHz with a 5 Hz resolution such that there are 10,000 positions. If the noise dataset characterizes the noise values to match this requirement, resizing is not necessary. On the other hand, a particular or targeted frequency range for analysis may not match the native requirement of the frequency selection AI model wherein the targeted frequency range is less than the frequency range of the original spectrogram. For example, if the targeted frequency range is 1 kHz or less for purposes of selecting a rebar frequency and/or band, frequency data above 1 kHz in the original noise dataset can be removed or cropped to produce an image. Once this cropping has been accomplished, the image can be expanded or resized along the frequency axis to fill the required predetermined dimension along that axis and maintain a high degree of fidelity with the original data. Of course, the frequency resolution along the frequency axis will change due to this expansion. For example, if the modified frequency dimension is 1 kHz with 10,000 positions, the resolution is then 0.1 Hz per position. In this case, each frequency bin of the original noise dataset corresponds to 10 frequency bins of the generated image. This expansion can be accomplished, for example, by duplicating determined noise values along the modified frequency axis. As another example, if the targeted frequency range excludes a rebar band below 1 kHz, frequencies at or below 1 kHz can be cropped to produce the image. After resizing, the modified frequency dimension is 49 kHz with 10,000 positions such that the resolution is 4.9 Hz per position.

Any suitable process can be utilized to accomplish resizing along either the frequency dimension or the time dimension as well as adjusting both the frequency dimension and the time dimension simultaneously. For example, any suitable interpolation process can be used including, but not limited to bilinear interpolation, bicubic interpolation and nearest neighbor. Generally, upscaling may be needed along the frequency dimension while downscaling may be needed along the time dimension. One suitable process can be a two-dimensional box filter (which is similar to bilinear interpolation) for purposes of downscaling, although any suitable process can be used. A two-dimensional box filter averages together neighboring pixels and inserts them into the output. For example, if there is a need to resize from 512 by 512 positions to 256 by 256 positions, then each dimension must be reduced to half the original size. Therefore, each 2 by 2 square of values in the input can be averaged together to fill each output position in an overall grid. Similarly, a box filter can be used to expand the image if the output is larger than the input by duplicating values in the output. As another example, if there is a need to expand from 256 by 256 positions to 512 by 256 positions, a copy of the data for each position can be inserted along the vertical dimension and adjacent to each existing position to double the size of the vertical dimension.

As another example, the intended purpose of the generated image can be to facilitate a region identification process which identifies regions along the time axis that share a common noise feature. The latter can arise, for example, due to the portable device being moved across a powerline frequency interference source such as a buried powerline. It is noted that the predetermined input requirements of an AI model dedicated to region identification may include a time axis resolution that is generally higher than the frequency axis resolution of an AI model that is dedicated to frequency selection to provide relatively higher sensitivity to changes along the time axis. Conversely, the predetermined input requirements of an AI model dedicated to frequency selection may include a frequency axis resolution that is generally higher than the resolution of an AI model that is dedicated to region identification to provide relatively higher sensitivity to changes in detected noise along the frequency axis. As a specific but non-limiting example, the frequency axis resolution requirement for a frequency selection AI model can be double that of the frequency axis resolution of a region identification AI model while the time axis resolution requirement for the frequency selection AI model can be one half of the frequency axis resolution of the region identification AI model.

At 368, preprocessing continues by normalizing the image. The original values are normalized to the range of 0 to 1 where 0 represents the data with the smallest dB noise value, and 1 represents the data with the largest dB noise value. Normalization maximizes the dynamic range of the input data, which can improve subsequent performance.

At 370, the generated image conforms to the specified predetermined input requirements and is available in processing data section 254 for subsequent processing. Such handling of the image involves one or more Artificial Intelligence (AI) models that were previously trained, as yet to be described, on a plurality of data sets of historical electromagnetic noise data. FIG. 7 is a block diagram that illustrates the architecture of one suitable embodiment of an AI model, generally indicated by the reference number 400 that can be used for purposes of selecting frequencies or bands as well as region identification. It is noted that each AI model used herein can be a Convolutional Neural Network (CNN), although this is not a requirement. AI model 400 includes an input layer 404, convolutional and pooling layers 408, a flattening layer 410, fully connected layers 414 and an output layer 418. Input layer 404 serves as an entry point for the AI model by receiving raw data from the outside world such as, for example, original spectrogram 250 of FIG. 4 and then passes data to the subsequent hidden layers for further processing. The input layer does not perform any computations itself, but instead distributes the input data across its neurons. Convolutional and pooling layers 408 include one or more convolutional layers that extract features from an input such as, for example, the spectrogram image by sliding a filter across the spectrogram to identify local patterns. One or more pooling layers cooperate with the convolutional layers to downsample the output of the convolutional layers, reducing the spatial dimensions and preserving the most important features of the spectrogram image, which can decrease computational complexity within the network. Flattening layer 410 can transform the output of convolutional and pooling layers 408 into a single, one-dimensional vector that is compatible with subsequent fully connected layers which require a linear input format, thereby acting as a bridge between convolutional and pooling layers 408 and fully connected layers 410 by converting the extracted features into a suitable format for further processing. Fully connected layers 414 are characterized by every neuron in a previous layer being connected to every neuron in the current layer such that each input is linked to every output, thereby creating a dense network of connections. In this way, every single piece of information from the previous layer influences every determination in the fully connected layers. Output layer 418 is the final layer of the neural network that produces the desired prediction. It receives processed data from the hidden layers and passes it on to the outside world. As will be seen, the AI models used herein can provide a variety of different results depending on the task at hand.

Applicant now brings to light an embodiment that does not require preprocessing in a way that addresses the problematic aspect of original noise datasets described above in generally failing to match the predetermined time dimension requirement of state-of-the-art AI models. In this embodiment, the process of FIG. 5 is executed in order to generate data segments that conform to the predetermined dimensions of a frequency selection AI model that will be used. In other words, the original noise dataset is divided into segments that can be fed directly into the AI model at least in terms of the time dimension. By way of non-limiting example, it is assumed that the predetermined dimension for the time axis is 20 positions at one second per position/slice. In terms of the frequency axis, the slices can be configured to match the predetermined input requirement along the frequency dimension. For example, the frequency axis can extend from 0 Hz to 50 kHz with a 5 Hz resolution such that there are 10,000 positions. Accordingly, a series of data segments can be generated with a 20 second duration for each data segment. If the operator walks an intended path with a time duration of 120 seconds, six data segments are generated. The capture process can be monitored by step 338 to establish the time at which 20 slices have been appended to form each data segment. Step 340 then can store each data segment in processing data section 254 for subsequent frequency analysis of each data segment in a manner that is consistent with the descriptions below. Based on analysis by the AI model, one or more frequencies can be selected for each data segment with no need for preprocessing. Given the relatively short time duration of the data segment, the application of region identification, described immediately hereinafter, may not be needed prior to frequency selection. Moreover, any data segment, for example, at the conclusion of the capture interval that does not match the predetermined time dimension can be discarded. The frequency selections on a per data segment basis can be ranked in any suitable manner for purposes of automatic selection and/or display of the finalized frequency selection(s).

### Region Identification

Referring to FIG. 4, it is assumed for purposes of the present discussion that the time scale also corresponds to distance along an intended path, for example, specified by a bore plan that transits an operational region. Applicant recognizes that electromagnetic noise or interference can exhibit significant variability across an operational region such that the best transmission frequency at any one location along the intended path may not be the best frequency at other locations. This variability is clearly evident in FIG. 4 by the presence of five distinct regions that are designated as R1-R5. Each region can be considered as sharing a common feature such as, for example, exhibiting powerline interference, transformer interference, traffic loop interference, reflected signal interference, industrial manufacturing interference and different combinations thereof. Applicant recognizes that the regions are not necessarily all distinct from one another. For example, regions R1 and R3 may share the same common feature. Likewise, regions R2 and R4 may share the same common feature. It is required, however, that any given region does not share the same common feature with the next or immediately adjacent region(s). In view of the foregoing and although not a requirement, Applicant recognizes that selecting transmission frequencies or bands on a per region basis can be of benefit based, for example, on the transmission capabilities of a given transmitter.

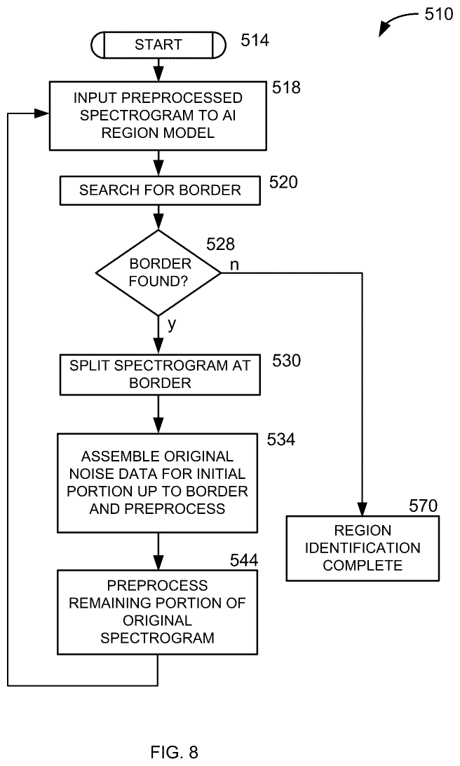

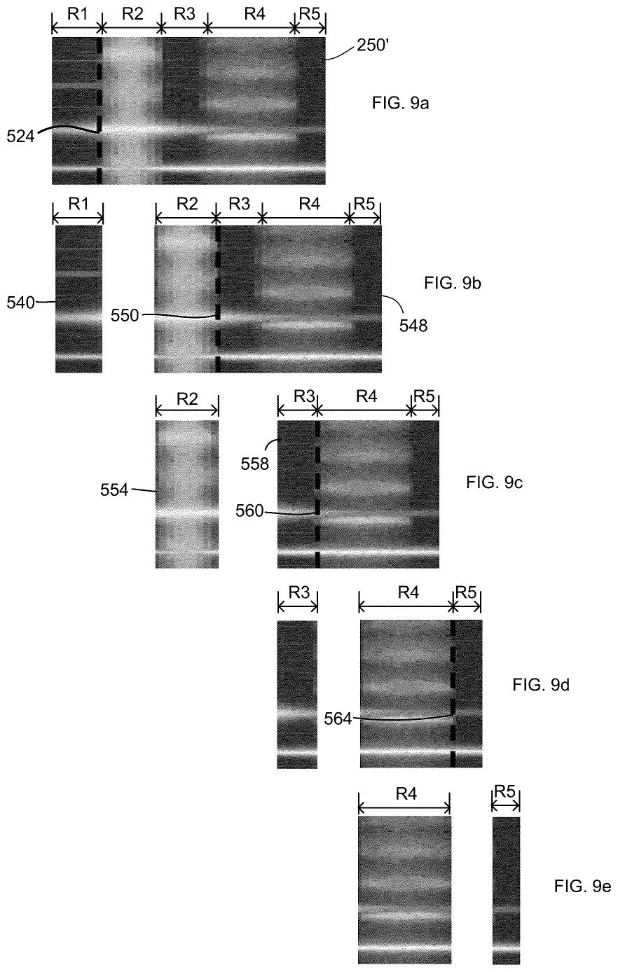

FIG. 2 illustrates a region identification AI model 500 in memory 200 for execution by processor 190. AI model 500 is shown using dashed lines, given that it is not required in some embodiments. AI model 500 is trained to identify a border between adjacent regions in an input noise dataset such that the input noise dataset is then split or divided at that border for subsequent processing. It is noted that that for the balance of the present discussion, the input noise dataset may be referred to as a spectrogram given that the referenced drawings represent the noise data in image form. FIG. 8 illustrates an embodiment of a method for spectrogram region identification and splitting, generally indicated by the reference number 510, while FIGS. 9a-9e illustrate a progression in the region identification process based on the method of FIG. 8. It is noted that FIGS. 9a-9e are in vertical alignment for purposes of enhancing illustrative clarity and show regions R1-R5, originally described with regard to FIG. 4. The method begins at start 514 and proceeds to 518 which receives an input spectrogram 250′ that has been preprocessed to conform to the predetermined input requirements of AI region identification model 500, as illustrated by FIG. 9a. In the present example, it is assumed that the predetermined input requirements for AI model 500 correspond to a 50 kHz range along the frequency axis with a 5 Hz resolution and 256 time slices along the time axis. At 520, AI model 500 searches for a border in modified spectrogram 250′ beginning from time zero. When a border 524 (FIG. 9a) is found, step 528 terminates and operation proceeds to step 530, which splits original spectrogram 250 at initial border 524. As illustrated by FIG. 9b, step 534 assembles a region R1 original spectrogram 540 from original noise data in original spectrogram 250 that corresponds to region R1, which can be stored in processing data section 254, while regions R2-R5 remain in combination comprised of corresponding original spectrogram data. The R1 original spectrogram can then be preprocessed in accordance with method 350 of FIG. 6, although this preprocessing step can be performed at any suitable subsequent time. Following step 534, step 544 assembles a region R2-R5 original spectrogram 548 corresponding to original noise data in original spectrogram 250, which can be stored in processing data section 254. Region R2-R5 original spectrogram 548 can then be preprocessed in accordance with method 350 of FIG. 6 to conform to the predetermined input requirements of AI model 500 and provided to step 518.

Method 510 continues by repeating step 520 to search for a border in the preprocessed R2-R5 spectrogram to find a border 550, as seen in FIG. 9b. When border 550 is found, step 528 terminates and operation proceeds to step 530, which splits original spectrogram 250 at this initial border 550 in the region (R2-R5) of interest. As illustrated by FIG. 9c, step 534 assembles a region R2 original spectrogram 554 from original noise data in original spectrogram 250 that corresponds to region R2, which can be stored in processing data section 254, while regions R3-R5 remain in combination. The R2 original spectrogram can then be preprocessed in accordance with method 350 of FIG. 6, although this preprocessing step can be performed at any suitable subsequent time. Following step 534, step 544 assembles a region R3-R5 original spectrogram 558 corresponding to original noise data in original spectrogram 250, which can be stored in processing data section 254. Region R3-R5 original spectrogram 558 can then be preprocessed in accordance with method 350 of FIG. 6 to conform to the predetermined input requirements of AI model 500 and provided to step 518. Subsequent looping through method 510 beginning at step 518 serves to identify a border 560 separating region R3 from the combination of regions R4 and R5. In FIG. 9d, step 530 identifies a border 564 separating region R4 from region R5. Upon returning to step 518 with a preprocessed spectrogram corresponding to the original R5 spectrogram, step 520 does not find another border such that step 528 routes operation to region identification complete step 570. At this junction, all of the regions have been identified and a preprocessed or modified spectrogram is available for each region for frequency identification purposes.

### Frequency Selection

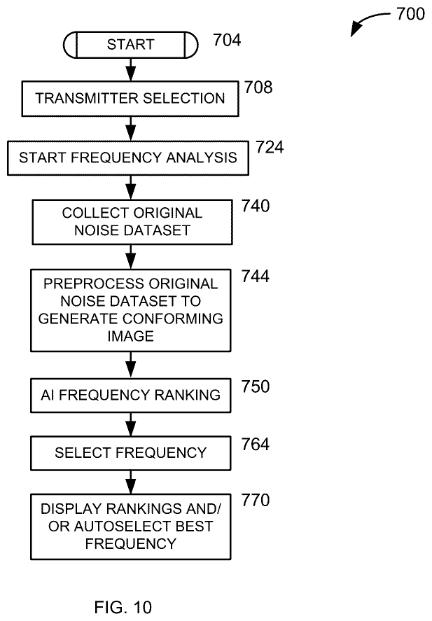

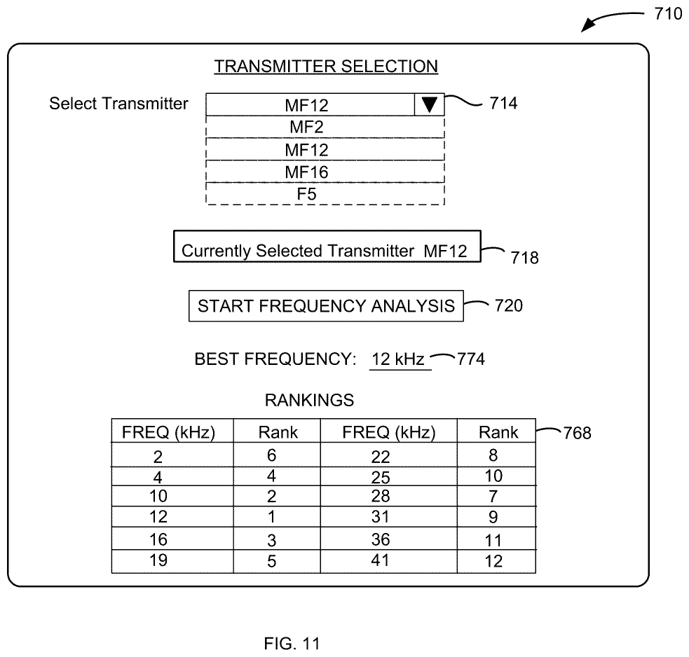

Frequency selection can begin based on which transmitter an operator intends to utilize for the inground operation at hand. In an embodiment, a catalog 600 (FIG. 2) can store information that characterizes a wide range of available transmitters, for example, relating to all the transmitters that are in service and/or available from a given manufacturer. Such information can include the particular frequencies or bands at which a given transmitter is capable of transmitting, power levels, details of trained AI models for specific purposes including predetermined input requirements for region selection and frequency/band selection. FIG. 10 is a flow diagram illustrating an embodiment of a method for operating portable device 20 for frequency selection purposes, generally indicated by the reference number 700. The method begins at 704 and proceeds to 708 which provides for user selection of a transmitter for an inground operation.

Referring to FIG. 11 in conjunction with FIG. 10, the former is an embodiment of a screen shot that can be presented on screen 40 (FIG. 1) of portable device 20, generally indicated by the reference number 710. A select transmitter dropdown menu 714 allows the operator to scroll through the available transmitters and select a transmitter for the current inground operation. Four different transmitters are shown as available. For purposes of the present example, it is assumed that the operator has selected a transmitter MF12 that is capable of operating at a selected one of twelve frequencies including 2 kHz, 4 kHz, 10 kHz, 12 kHz 16 kHz, 19 kHz, 22 kHz, 25 kHz, 28 kHz, 31 kHz, 36 kHz and 41 kHz. A currently selected transmitter window 718 shows the selected transmitter to confirm the operator selection. Having selected a transmitter, the operator can select a start frequency analysis button 720 such that frequency analysis is initiated at step 724 of FIG. 10.

At step 740 of FIG. 10, original noise dataset 250 is collected, for example, as the operator moves along intended path 26 (FIG. 1) across the surface of the ground in a manner that is consistent with the descriptions of FIG. 4 above. Initiation and termination of noise collection can be performed, for example, responsive to operator actuations of trigger button 48. At step 744, the original noise dataset is preprocessed, as needed, to generate an image that conforms to the predetermined input requirements of the AI(1) frequency selection model, which is the only AI model needed to implement the present embodiment. Preprocessing can be performed based on method 350 of FIG. 6 and related descriptions. The generated image is then available for frequency selection by AI(1) which can be previously trained at least for the transmitters in catalog 600 that transmit at a discrete or modulated frequency.

At 750, the AI(1) model can rank the frequencies of interest at least corresponding to the frequencies at which the currently selected transmitter (MF12) is capable of transmitting. At step 764, the AI(1) model can select the best frequency based on the rankings. In FIG. 11, a rankings table 768, as reflected by step 770 of FIG. 10, can be presented to the operator showing the ranking for every frequency of the selected transmitter accompanied by selecting the best frequency. The frequencies can be ranked based on a score for each frequency. Each score can be a numeric value that is in a range from 0 to 1 with higher scores being determined to provide the best performance in terms of noise immunity. In the present embodiment, the rankings are shown as whole values from 1-12. In another embodiment, the rankings can be presented as the actual scores. In this regard, any suitable scheme can be used to present the rankings in terms of relative values. In an embodiment, a best frequency 774 can automatically be displayed to the user which is 12 kHz in the present example. It is noted that the operator can repeat this entire process by reselecting start frequency analysis button 720. It should be appreciated that in the instance that the transmitter is capable of transmitting at multiple power levels such as, for example, low, medium and high power, some embodiments of the rankings table can also specify a recommended power level for each frequency. In an embodiment, the recommended power level can be determined based on a predicted depth (described below) for that power level and a desired depth that can be specified by the operator. In cases where the predicted depth is close to the specified desired depth for a given power level, a buffer zone can be applied such that the next higher power level is recommended to accommodate potential variations in the ambient noise.

In one embodiment, the AI(1) model can be trained for a combination of all the discrete and/or modulated frequencies represented by the combination of transmitters supported in catalog 600. For example, if a total of 16 frequencies is supported by the combination of transmitters MF2, MF12 and MF16 in FIG. 10. The AI(1) model can always rank all sixteen frequencies irrespective of which transmitter was selected by the operator, but only present the specific frequencies associated with the selected transmitter to the operator in rankings table 768. In another embodiment, a dedicated AI model can be trained for each selectable transmitter and stored, for example, in catalog 600.

Frequency selection can also be made on a per region basis. In such an embodiment, the regions can be identified in the manner that is described with respect to FIGS. 8 and 9a-9e. Once the regions are identified, original noise data corresponding to each region can be preprocessed to produce a region image conforming to the predetermined input requirements of a frequency selection AI model to be used. In an embodiment and assuming that five regions are identified, the region images can be analyzed in series, for example, by the AI(1) model in a manner that is consistent with the descriptions above. In another embodiment, the region images can be frequency analyzed in parallel using AI models AI(1) to AI(5) where each one of the AI models can be an identical instantiation. In either case, the frequencies of the selected transmitter are independently ranked for each region with a preferred or best frequency identified for each region.

For a transmitter that is capable of transmitting at two or more rebar frequencies, for example, below 1 kHz, method 700 of FIG. 10 can be utilized to select the best rebar frequency as well as scoring the frequencies relative to one another. In this instance, preprocessing at step 744 can invoke cropping the frequencies above the rebar band before conforming a rebar selection image to the predetermined input requirements of an AI(sub-k) model 780 (FIG. 2) that is trained on a plurality of historical electromagnetic rebar or sub-k noise data sets.

### Predicted Depth

Attention is again directed to noise dataset 250 of FIG. 4. It should be appreciated that key 310 also shows a depth in feet, which can just as readily be in meters. In an embodiment, the noise dataset can be subject to a conversion such that it characterizes predicted depth values instead of noise values. In this case, it may be appropriate to refer to the result of the conversion as a predicted depth map which is made up of a grid of depth values. In one embodiment, the entire noise dataset can be converted to depth such that each value in the noise dataset is converted and replaced. In this way, the resulting predicted depth map characterizes the same dimensions as the original noise dataset. In another embodiment, the ambient noise data can be converted to predicted depth as the ambient noise data is collected. For example, when a vertical slice of ambient noise data is received, the slice can be converted to predicted depth prior to being appended to the horizontally expanding depth map. This latter approach amortizes processing delays, which is to say that the process will appear to execute faster to the end user. Of course, if a predicted depth map is used instead of a noise dataset, the neural networks must be trained to use predicted depth instead of noise amplitude, as will be discussed in detail at an appropriate point hereinafter.

It is noted that any suitable technique can be used to determine predicted depth values in the context of the embodiments described herein. In terms of determining predicted depth values for an individual or discrete frequency that is modulated, the technique brought to light in the aforementioned '901 patent remains applicable. The subject technique is based on the ability to maintain an acceptable bit error rate in view of measured ambient electromagnetic noise. Another suitable technique is described in commonly owned U.S. patent application Ser. No. 18/986,635, filed on Dec. 18, 2024 and entitled ADVANCED PREDICTED DEPTH AND SCALED NOISE TECHNIQUES WITH ASSOCIATED DISPLAYS, APPARATUS AND METHODS which is incorporated herein by reference. The predicted depth, as presented below, is a function of the inverse cube root of signal strength. Specifically, this involves a ratio of the cube root of a reference signal strength at a known, reference distance, to the cube root of the signal strength of a noise measurement. For a given frequency the predicted depth can be expressed as:

$${Depth}_{pred} = {Depth}_{ref} \times {10}^{[ \frac{Δ - C}{60} ]} \qquad ( EQN . 1 )$$

Where Depth_{ref} is a depth or distance at which a given transmitter produces a known amount of signal strength, SS_{ref}, measured in dB at a given frequency and power level. It should be appreciated that for a transmitter that is capable of transmitting any given frequency at two or more power levels, a different value of SS_{ref} can be used for each power level. For example, Depth_{ref} can be 10 feet with the given transmitter placed in a standard housing positioned on the surface of the ground spaced away from a suitable signal strength measuring device in a manner that is consistent with the descriptions above. Such a signal strength measuring device, for example, can be portable device 20, although this is not a requirement and any suitable device can be used. The variable Delta, A, can be expressed in dB and can be written as:

Δ=SS_{ref}−Noise (EQN. 2)

Where Noise is the measured electromagnetic noise at the given frequency. This value can be a live noise reading or an average value. The variable Cis a constant which serves as a buffer or offset to ensure that the received signal strength at the predicted depth is ultimately greater in magnitude than the measured noise. In an embodiment, C can be 3 dB although any suitable value can be used. By way of example using 3 dB for the value of C, if the given transmitter transmits the given frequency with a signal strength of −20 dB at a distance of 10 feet and the measured noise at the given frequency is −70 dB the value of Δ is [−20−(−70)] which evaluates to 50 dB. If the value of C is 3 dB, [(Δ−C)/60] evaluates to [(50−3)/60] which evaluates to 0.783. The maximum predicted operational depth, Depth_{pred}, is then [10×6.07] or approximately 60.7 feet.

In some embodiments, compensation can be applied to the predicted depth map. For example, a transmitter calibration can be applied, so that the AI model can select frequencies that take into account the frequency response of the transmitter. The AI model to be used need not be trained in any special or different way to accomplish this, since the compensation can be a result of adjusting the predicted depth data for frequency response before inputting the data to an AI model via a predicted depth map.

Once the predicted depth map is complete, all downstream operations are equivalent for the purpose of selecting a frequency based on predicted depth rather than on noise. For purposes of frequency selection, the AI(1)-AI(n) models can be trained on sets of historical predicted depth data. Of course, the objective is to perform frequency selection and ranking in terms of predicted depths such that a relatively higher value of predicted depth is associated with a relatively more preferable frequency and the best frequency can be associated with the greatest value of predicted depth.

Applicant recognizes that the determined predicted depth values are on a linear scale while the measured noise values are on a logarithmic scale. One aspect of this difference with respect to using predicted depth which may be of benefit is that linear data can be less challenging for an AI model to process than logarithmic data, although either can be used.

### Frequency Band Selection

Having described embodiments for frequency selection in detail above, embodiments for frequency band selection will now be described in detail. In this regard, it should be appreciated that many aspects of band selection are shared with the frequency selection process described above. In particular, collection of the original noise dataset, as described with regard to FIGS. 4 and 5, and preprocessing the original noise dataset in accordance with FIG. 6 and its associated descriptions are unchanged. Likewise, the region identification process of FIG. 8 can be unchanged.

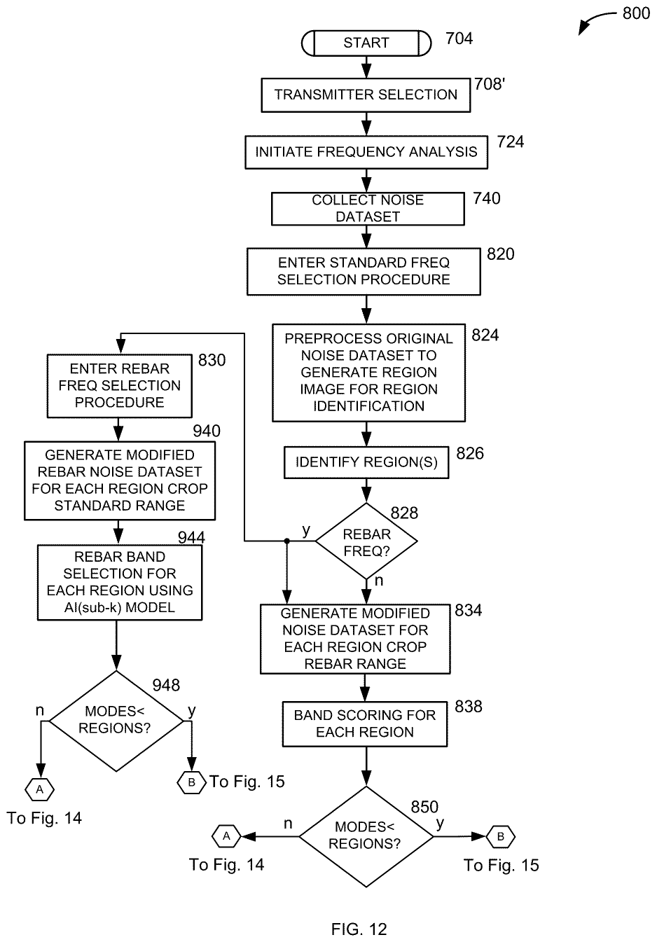

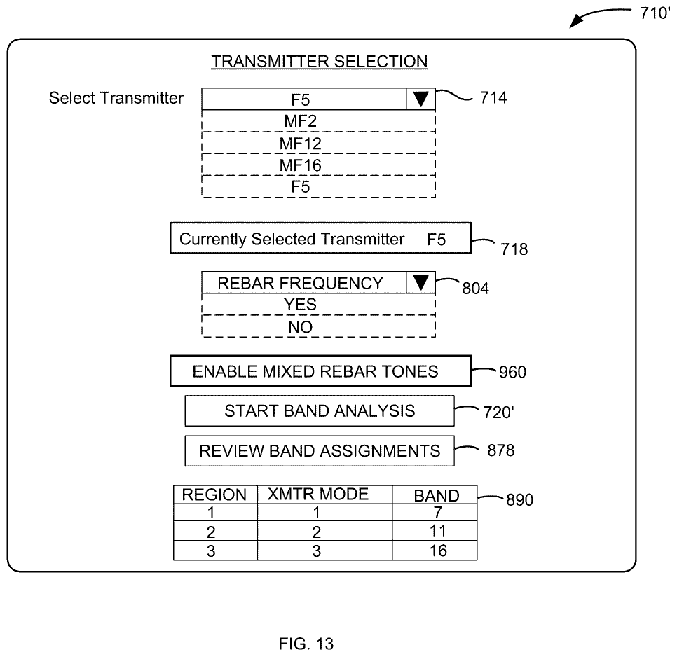

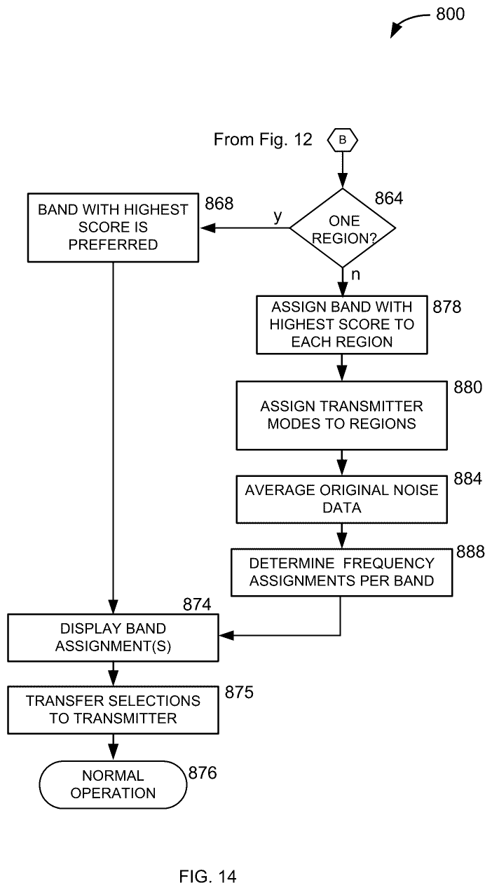

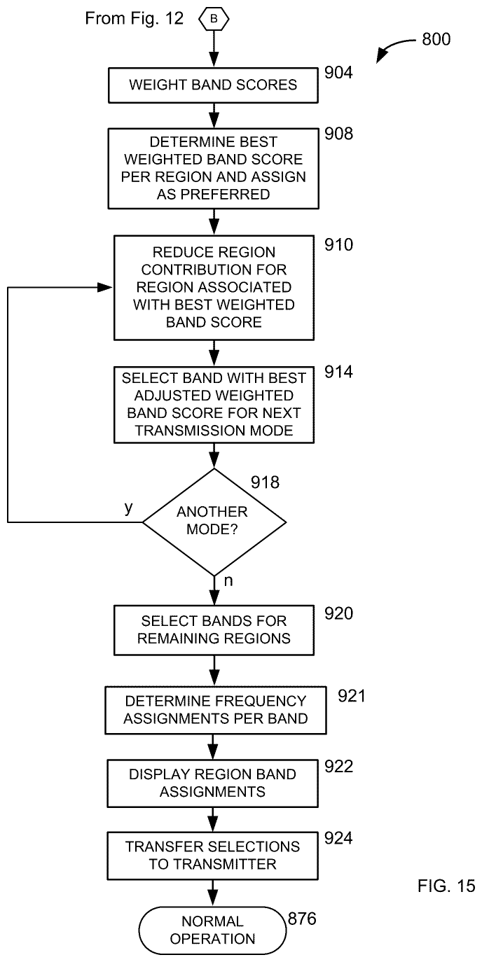

Referring to FIG. 12, an embodiment of a method for frequency band selection is generally indicated by the reference number 800. It is noted that method 800 shares steps with method 700 of FIG. 10. Accordingly, descriptions of the shared steps may not be repeated for purposes of brevity, for example, relating to noise dataset collection, preprocessing and region identification, with the reader being referred to the appropriate descriptions above.

Attention is directed to FIG. 13 in conjunction with FIG. 12. The former is a screenshot, generally indicated by the reference number 710′, which is based on screenshot 710 of FIG. 11. In this instance, a band selection process can be initiated by the operator selecting transmitter F5 in transmitter selection window 714 at step 708′ of method 800. It is noted that transmitter F5 transmits data as multi-bit symbols in accordance with the above incorporated '140 patent such that each multi-bit symbol can be transmitted at a unique frequency within a selected band as well as simultaneously continuously transmitting an unmodulated depth tone or frequency. Table 1 below lists an embodiment of bands that can be used by portable device 20 and, of course, by a corresponding transmitter 130.

TABLE 1
TRANSMITTER FREQUENCY BANDS

| | Start | | |
|---|---|---|---|
| Band | Frequency | End Frequency | Remarks |
| 0.3 | 330 Hz | 400 Hz | Rebar depth tone only |
| 0.5 | 405 Hz | 575 Hz | Rebar depth tone only |
| 0.7 | 580 Hz | 750 Hz | Rebar depth tone only |
| 3 | 2.5 kHz | 3.5 kHz | Rebar depth tone only |
| 7 | 4.5 kHz | 9 kHz | Standard band |
| 11 | 9 kHz | 13.5 kHz | Standard band |
| 16 | 13.5 kHz | 18 kHz | Standard band |
| 20 | 18 kHz | 22.5 kHz | Standard band |
| 25 | 22.5 kHz | 27 kHz | Standard band |
| 29 | 27 kHz | 31.5 kHz | Standard band |
| 34 | 31.5 kHz | 36 kHz | Standard band |
| 38 | 36 kHz | 40.5 kHz | Standard band |
| 43 | 40.5 kHz | 45 kHz | Standard band |

Bands 0.3, 0.5 and 0.7 are rebar bands. Accordingly, 330 Hz to 750 Hz comprises a rebar frequency range. Bands above the rebar range can be referred to collectively as the standard range. It is noted that the frequency bands are non-overlapping. In the present example, the upper limits of bands 7, 11, 16, 20, 25, 29, 34 and 38 can be exclusive while the lower limits can be inclusive. Ultimately, a selected frequency can be chosen from one of the rebar bands and subsequently transmitted as a rebar depth tone. In the present embodiment, no symbol frequencies are transmitted in the rebar frequency range. If the operator suspects that passive interference may be present along at least a portion of the intended path, the operator can choose a select rebar frequency menu 804 in FIG. 13. In the present example, it is assumed that the operator has selected “Yes”. Frequency analysis at step 740 can begin responsive to the operator selecting start frequency band analysis button 720′. At 820, a standard frequency selection procedure is entered. Details with respect to an embodiment of a rebar frequency selection procedure will be provided at an appropriate point below. At 824, the original noise dataset is preprocessed to generate a region image for region identification. It should be appreciated that region identification is not a requirement. It is noted that if rebar frequency selection is to be performed, the same region(s) from step 826, yet to be described, can be used in the rebar frequency selection procedure. In the present example, frequencies below band 3 of Table 1 can be cropped or removed for purposes of the standard frequency analysis such that the frequency axis extends from 2.5 kHz to 45 kHz prior to region identification. The region image can be generated in accordance with the descriptions of FIG. 8 such that the region image conforms to the predetermined input requirements of region identification AI model 500 (FIG. 2). If region identification is not needed, the generated image can instead conform to the predetermined input requirements of the AI(1) model.

At step 826, region identification is performed, for example, in the manner described above with regard to FIGS. 8 and 9a-9e. In FIG. 12, the selection indicating whether to identify a rebar frequency is confirmed at step 828 and operation enters a rebar frequency selection procedure at 830 which can operate in parallel with the standard frequency selection procedure and which will be described in further detail below. If the operator previously indicated that a rebar frequency is not needed, step 828 causes the method to enter the standard frequency selection procedure without initiating the rebar frequency selection procedure.

At 834 Assuming that five regions have been identified, a region specific image can be generated at 834 for each region based on the original noise data corresponding to each identified region and conforming to the predetermined input requirements of a band selection AI model. An independent band selection procedure can be performed for each region. In the present example, it is assumed that five band selection models AI(1) to AI(5) perform band selection in parallel, although this is not a requirement. At 838, band scoring is performed such that each region receives per band scores, as will be further described. In another embodiment, a single band selection AI model can handle the regions in series. In still another embodiment, the number of band selection AI models used can be determined or customized based on processing capabilities. It is noted that the band selection procedure can begin immediately after a region is identified such that steps 826 and 838 can essentially operate in parallel in some embodiments, although this is not a requirement.

The output from the band selection AI model for any one of the regions at step 838 is a list of scores: one score for each band. Accordingly, the scores are on a per region basis and are independent for each region. A score can be a numeric value between 0 and 1, where bands with higher scores are those which the neural network(s) determined to provide the best performance. Table 2 below is an example of scores for region R1.

TABLE 2
BAND SELECTION SCORES

| BAND (kHz) | SCORE |
|---|---|
| 7 | 0.014 |
| 11 | 0.655 |
| 16 | 0.004 |
| 21 | 0.031 |
| 25 | 0.029 |
| 29 | 0.012 |
| 34 | 0.223 |
| 38 | 0.008 |
| 43 | 0.024 |

After having executed the band scoring process, a set of band scores for each region is available. At step 850 of FIG. 12, the number of transmitter modes is compared to the number of regions. If the number of transmitter modes is greater than or equal to the number of regions, operation routes to step 864 of FIG. 14. At step 864, the method tests for whether there is only one region. If so, operation routes to step 868 which assigns the band having the highest score as the preferred band. In the example of Table 2, the preferred band would be band 11 with a score of 0.655. Responsive to the operator choosing a review band assignments button 870 in FIG. 13. The display screen can indicate the selection of band 11 which can be modified by the operator at step 874. At 875, the selections can be transferred to the transmitter, for example, using external com module 210 (FIG. 2). At 876, normal system operation can be entered, for example, performing a drilling operation.

It is now assumed that the decision at step 864 involves a hypothetical set of three regions instead of just one region. It is further assumed that the selected transmitter includes three modes such that one mode can be associated with each region and the transmitter can transmit in each of bands 7, 11 and 16. Based on this scenario, step 864 determines that there are multiple regions such that operation routes to step 878. Table 3 provides sample band scores for the three regions.

TABLE 3
SAMPLE BAND SCORES

| | REGION 1 | REGION 2 | REGION 3 |
|---|---|---|---|
| BAND 7 | 0.6 | 0.1 | 0.2 |
| BAND 11 | 0.1 | 0.8 | 0.2 |
| BAND 16 | 0.3 | 0.1 | 0.6 |

The band score that is the highest for each region is shown in bold. Given that there are three bands and three modes, step 878 can assign the band having the highest score for any given one of the regions to that region. Using the scores of Table 3, band 7 is assigned to region 1, band 11 is assigned to region 2 and band 16 is assigned to region 3. In an embodiment, the transmitter modes can simply be assigned by step 880 in ascending order such that transmitter mode 1 is assigned to region 1, transmitter mode 2 is assigned to region 2 and transmitter mode 3 is assigned to region 3.

In another embodiment, step 880 can assign the transmitter modes based on weighted scores for the bands. With the band scores of Table 3 in hand, the regions can be weighted as part of step 880. Each region is assigned a weight based on the relative size of the region. If GPS position information is available, then the weight is a percentage based on the physical length of the region relative to the length of the full data collection set forth in the original noise dataset. If GPS position information is not available, then the weight is instead based on the time duration of the region relative to the time duration of the full data collection. The region weights can be values between 0 and 1, representing a region's size relative to the full data collection. As an example of time-based weighting: a region that takes 25 seconds of a 100 second noise dataset receives a weight of 25%. As an example of GPS-based weighting: if the total distance between the start of end of the noise dataset is 250 feet, then a region that starts at the beginning of the noise dataset and travels for 100 feet will receive a weight of 40%. In the present example, region 1 is assumed to be 80% of an overall total, region 2 is 15% of the total and region 3 is 5% of the total. It is noted that these percentages can represent either percentages of total distance or percentages of total time. In this embodiment, the transmitter modes are assigned such that the region with the largest weight (i.e., the region of largest size) is assigned to the first transmitter mode. The second largest region is assigned to the second transmitter mode, and so on. Accordingly, at step 880, the regions are assigned transmitter modes in the same manner as the last embodiment, given the determined region weights. That is, region 1 is assigned transmitter mode 1, region 2 is assigned transmitter mode 2 and region 3 is assigned transmitter mode 3. At step 884, ambient noise data from the original input noise dataset (not cropped, resized, normalized, or otherwise processed) is averaged together, per the following method: ambient noise values from within each region are averaged together per FFT bin. In this regard, each region can encompass multiple slices with a different ambient noise value associated with each FFT bin in each slice. The result of this step is a single dB noise value for each FFT bin which is an average of the ambient noise across the region, irrespective of the number of slices that make up the region. At step 888, symbol frequencies and a depth frequency in each band can then be determined, in one embodiment, based on these per region FFT bin average values, for example, in a manner that is consistent with the descriptions in the above incorporated '140 patent. In another non-limiting embodiment which assumes that the transmitter uses a depth tone and sixteen symbol frequencies, the lowest frequency in each band having an average noise value that satisfies a low noise threshold can be set as the depth tone and the next sixteen higher frequencies in each band having average noise values that satisfy the low noise threshold can be assigned as symbol frequencies. The low noise threshold, for example, can be determined based on a desired depth specified by the user. At 874, the band selections can be displayed, for example, in FIG. 12, responsive to the operator selecting a review band assignments button 878 which shows a band selection table 890 including the band selected for each one of the three regions.

Turning again to FIG. 12 and, in particular, step 850, if it is determined that the number of transmitter modes is less than the number of regions, operation routes to step 904 of FIG. 15. For purposes of simplicity, it is assumed that band scoring process 838 was directed to bands 7, 11 and 16 given that that transmitter is capable of transmitting in these three bands. The bands receive scores as set forth in Table 3 above.

With these band scores in hand from the band scoring process, the regions are weighted at step 904. For purposes of the present example, it is assumed that the weighting is unchanged from the descriptions immediately above. Weighted region band scores can be determined by multiplying the band scores of Table 3 by the percentage of each region as a weighting factor to yield the weighted band scores shown in Table 4.

TABLE 4
WEIGHTED BAND SCORES

| | Region 1 | Region 2 | Region 3 | Total |
|---|---|---|---|---|
| Band 7 | 0.48 | 0.015 | 0.01 | 0.505 |
| Band 11 | 0.08 | 0.12 | 0.01 | 0.21 |
| Band 16 | 0.24 | 0.015 | 0.03 | 0.285 |

At 908 and within each region, the highest weighted band score is determined. The highest score is then preferred for its associated region. Accordingly, band 7 is assigned as a region-preferred band to region 1 in a first mode of the transmitter. In Table 4, the scores of all the region-preferred bands are shown in bold. Also in Table 4, the weighted band scores for each band are combined together as shown in the Total column. This produces a region-independent overall band score for each band. As will be seen, the best n bands can be determined from the overall band scores, where n can vary dynamically depending on the number of transmitter modes. For purposes of the present example, it is assumed that n is equal to 2. The first of the best bands has already been determined as band 7 above. At this point, one might assume that band 16 is the second best, because it has the second highest total score. However, this is only because region 1 is very large (80%) compared to regions 2 and 3, and heavily skews the results. Band 16 is preferred for region 3, but region 3 is smaller than region 2, so region 2 should be prioritized over region 3. This can be accomplished, for example, by continuing to rely on the total weighed band scores rather than the weighted band scores on a per region basis. Accordingly, at step 910, after selecting the best score (region 1, band 7), the contribution from region 1 is substantially reduced. The amount of reduction can be, for example, determined such that a very large score in a given region does not produce an undue bias against selections in other regions. After reducing the region 1 score by 95%, a set of adjusted weighted band scores is given by Table 5.

TABLE 5
ADJUSTED WEIGHTED BAND SCORES

| | Region 1 | Region 2 | Region 3 | Total |
|---|---|---|---|---|
| Band 7 | 0.024 | 0.015 | 0.01 | 0.049 |
| Band 11 | 0.004 | 0.12 | 0.01 | 0.134 |
| Band 16 | 0.012 | 0.015 | 0.03 | 0.057 |

At 914, based on the total adjusted weighted band scores of Table 5, band 11 has the highest total score of 0.134 and, therefore, becomes the second best option and is selected for the second mode of the transmitter and assigned to region 2 as a preferred band given that region 2, band 11 now has the highest score (0.12) for the region. This is a desirable result, because band 11 is better for region 2. At step 918, it is determined whether another transmission mode is available to receive a band assignment. Given that the transmitter has two modes in the context of the present example such that no additional transmission mode is available, operation moves to step 920 which assigns one of the bands that has been selected thus far to each remaining region. In the present example, band 7 is assigned to region 3 given that there is a tie between bands 7 and 11 for region 3. Selecting the lower frequency band may provide better performance if passive interference is encountered. Any additional remaining regions receive mode/band assignments based on the weighted band scores for the additional regions. At 921, frequency assignments can be made on a per band basis, for example, based on the description of step 888 above. At 922, the mode or band assignments can be displayed in a mode assignments table, as show below, and which can be presented in the display of FIG. 12, for example, in place of table 890. In this instance, review band assignments button 878 can be changed to a review mode assignments button.

TABLE 6
MODE ASSIGNMENTS

| REGION | XMTR MODE | BAND |
|---|---|---|
| 1 | 1 | 7 |
| 2 | 2 | 11 |
| 3 | 1 | 7 |

At step 924, the band selections can be transferred to the transmitter, for example, using external com 210 (FIG. 2) in a manner that is consistent with the descriptions above. At step 876, normal operation can be entered.

With reference to FIG. 12, operation of rebar frequency selection procedure 830 will now be described in detail. At 940, a modified rebar noise dataset is generated for each region. As part of this, the standard frequency range can be cropped. At 944, rebar band selection is performed for each region using the rebar AI(sub-k) model 780 of FIG. 2. Rebar band selection is performed such that each region receives per rebar band scores. This process can be essentially no different than the standard band selection process described with regard to step 838 above. Accordingly, the result is a score for each of rebar bands 0.3, 0.5 and 0.7. Generally, only one instantiation of rebar model 780 is needed, although the use of multiple rebar models is acceptable. At 948, the number of transmission modes for the rebar depth tone is compared to the number of regions which reflects the descriptions of step 850 above. It is noted, however, that the number of transmission modes for the rebar depth tone may not match the number of modes for transmission in the standard frequency range. Dependent upon the desired outcome, the number of transmission modes and the number of regions can be customized such that step 948 routes to the appropriate one of steps 864 (FIG. 14) or 904 (FIG. 15) such that the rebar frequency selection process can operate in parallel with the standard frequency selection process. Of course, no more than one depth tone need be selected for each one of the rebar bands as is the case for standard bands. Referring to FIG. 13, in an embodiment, a mixed rebar tone button 960 can be enabled that uses rebar tone(s) from the rebar band and rebar tone(s) from the standard bands in a customized manner. By way of non-limiting example, in a first mode of the transmitter, a depth tone selected from the rebar band is used while, in a second mode of the transmitter, a depth tone selected from a standard frequency band is used.

As discussed above, stored data can be in terms of predicted depth rather than ambient noise values. The band selection processes brought to light above are readily adaptable to the use of predicted depth wherein better bands are characterized by relatively higher values of predicted depth, as reflected by relatively higher band scores. In this case, various AI models can be trained on sets of historical predicted depth data that are directed to frequency band selection. Once band scores are available based on predicted depth, the methods described above can proceed in an essentially unchanged manner.

### Training

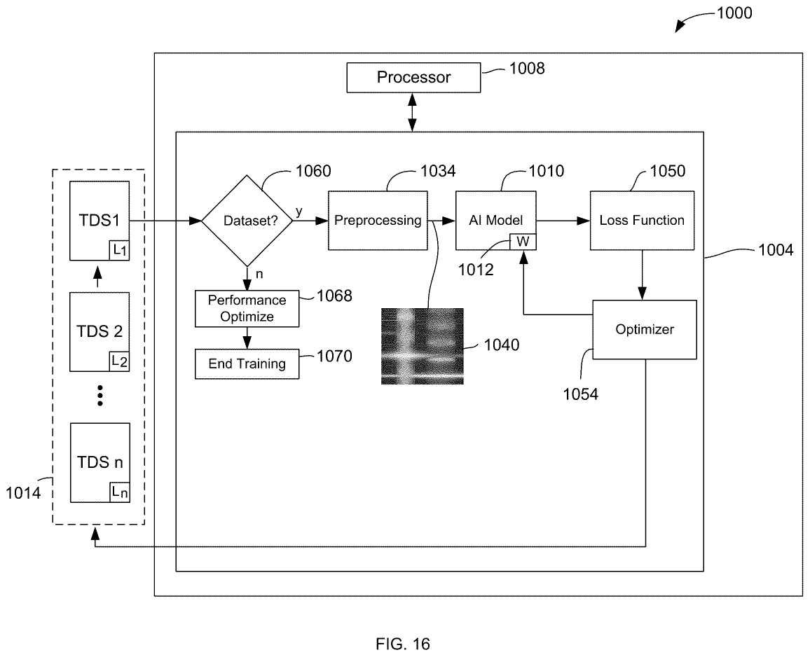

Attention is directed to FIG. 16 which is a block diagram illustrating an embodiment of a training system, generally indicated by the reference number 1000, for training the various AI models employed herein. A memory 1004 stores the various functional blocks under the management of a processor 1008. An AI model 1010 is implemented in memory 1008 which includes a set of weights W indicated by the reference number 1012. It should be appreciated that a neural network (i.e., AI model) must be trained with predefined data before the neural network can be useful. An untrained AI model will produce random results, because it is typically initialized with random weights. The goal of the training process is to make the neural network mimic a desired behavior. Training a neural network requires training data. Training data can consist of real-world data (from real jobsites, for example) or training data can be simulated. Real-world training data is preferred, because simulated data may not perfectly recreate the subtleties present in real-world data. Real-world training data could, for example, be collected from portable device 20 in-situ while the user is performing a frequency optimization.

As shown in FIG. 16, training data can comprise an input set of training data 1014 which can be stored externally at any suitable location as shown by the figure or stored internal to memory 1004. The training data can be provided as a plurality of input datasets designated as Training Data Sets (TDS) 1 through n wherein n is the last training dataset in an overall series. It should be appreciated that the Training Data Sets can comprise noise readings versus frequency or specify predicted depths versus frequency. Generally, the greater the number of training datasets, n, the more accurate the subsequent predictions made by the AI model will be. For purposes of the present example, it is assumed that a frequency selection AI model is being trained. Each TDS includes a label L₁-Lₙ, respectively, which provide an expected output for that TDS. In the instance of using either an ambient noise regime or a predicted depth regime for frequency or band selection, the labeling identifies one or more frequencies or frequency bands that are considered as the correct choices. Labeling is typically applied manually. An individual experienced in the art of selecting proper frequencies or frequency bands can label the training datasets. In this way, the AI model will “learn” to select frequencies or frequency bands in the same way as the trained individual. Similarly, an experienced individual can identify a border in a TDS for region identification purposes. In any case, the training data should be of high quality with the labeling correct and consistent. Otherwise, the AI model may “learn” faulty behaviors. Additionally, the training datasets should be sufficiently varied, so that all possible outputs are frequently exercised. A neural network operates best when the input data is similar to data it was trained with, and is less capable when given data that is substantially different from any training data. It should be appreciated that training datasets can be directed to address differing frequency or band selection concerns beyond just ambient noise. For example, some training data can be directed to selecting a band or frequency that is relatively lower in frequency as a precaution against encountering passive interference. Other training datasets can include localized active interference or location dependent noise which can appear as a spike in ambient noise along an intended path. As another example, an AI model can be trained to compensate for at least one of a transmitter frequency response and desired depth (entered manually by an operator or specified by a bore plan). For example, training in terms of transmitter frequency response compensation would account for a signal traveling further at a lower frequency than a higher frequency at a given signal strength. Additionally, the impact of noise/interference would be adjusted based on the desired depth, as interference will generally have a bigger impact at deeper depths and less impact at shallower depths.

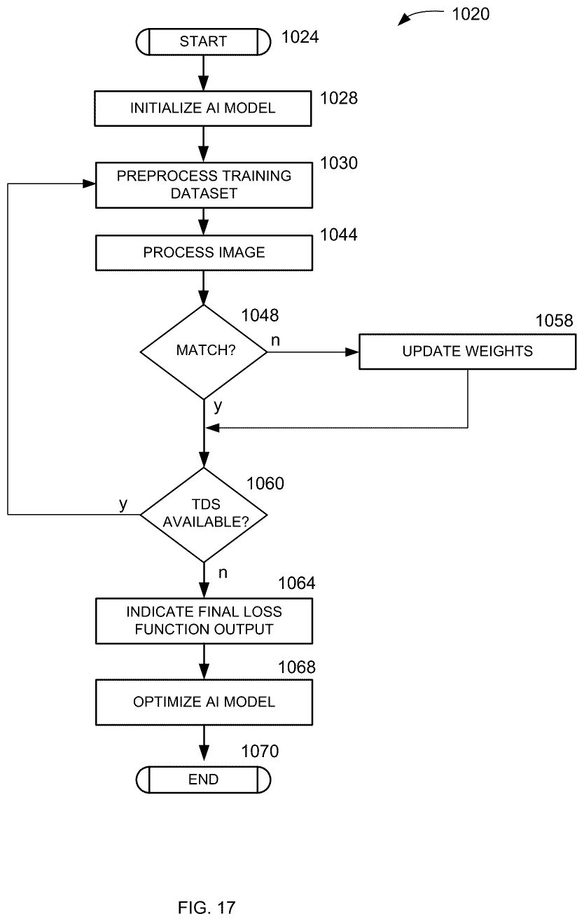

Turning to FIG. 17 in conjunction with FIG. 16, the former is a flow diagram that illustrates an embodiment of a method for operating training system 1000, generally indicated by the reference number 1020. The method begins at start 1024 and proceeds to 1028 which initializes weights W of AI model 1010 that can be random weights. This is generally the approach taken with respect to many AI models as a standard practice given that random weights can serve to reduce the likelihood of hitting a local minimum (that is, a suboptimal solution) while training. At 1030, the first training dataset TDS₁ is preprocessed by a preprocessing section 1034 in accordance with the descriptions above to generate an image. The generated image conforms to the predetermined input requirements of the AI model which can be directed to frequency/band selection or region identification. The preprocessing applied here for training purposes is essentially no different than the preprocessing described above in the Preprocessing section of the present disclosure for frequency selection, band selection or region identification. In the case of band-selection, the labeling can be a unique 0 indexed integer which indicates the preferred band that a properly trained model should select. For example, the following indexes can be applied for a wideband transmitter using what are referred to as the standard bands shown earlier in Table 1:

TABLE 7
BAND INDEX ASSIGNMENTS

| Index | Band |
|---|---|
| 0 | 7 kHz |
| 1 | 11 kHz |
| 2 | 16 kHz |
| 3 | 20 kHz |
| 4 | 25 kHz |
| 5 | 29 kHz |
| 6 | 34 kHz |
| 7 | 38 kHz |
| 8 | 43 kHz |

In the case of the region identification neural network for either the ambient noise regime or the predicted depth regime, the labeling for a region identification AI model can include two values: the first can be a Boolean flag to indicate whether a region split is present, and the second can be a floating-point number which indicates the relative X coordinate (i.e., along the time/distance axis) where the spectrogram is split into two parts. The X coordinate can be an index indicating the vertical slice at which the split should be performed, or it may be normalized to between 0 and 1 (inclusive). Generally, best practice in the field of neural networks is to normalize, but either option is workable.

Subsequent to preprocessing, a preprocessed image 1040 is provided to AI model 1010 and processed at step 1044 to yield a predicted output. Step 1048 compares the predicted results from step 1044 to the labeling using a loss function 1050 which determines if there is a difference between the predicted results and the labeling. If there is a difference (i.e., no match), operation routes to an optimizer 1054, the optimizer determines updated weights W based on a difference between the predicted results and the labeling. It is noted that this process can be referred to as backpropagation. The weights W are updated at 1058. Subsequent to step 1058, operation routes to step 1060 which will be described below.

If step 1048 determines that the predicted output matches the labeling, operation proceeds directly to step 1060 which establishes whether another TDS is available. If so, operation returns to step 1030 to preprocess the next TDS and the operation continues as described above. It is noted that this iterative process can be repeated potentially millions of times dependent upon the amount of available training data. Once step 1060 establishes that no more training data is available, operation then routes to step 1068 which is not required but can convert the trained AI model to a format for enhanced performance on a relatively lower power embedded type processor and can be accomplished, for example, using a suitable machine learning development platform. While this serves to shrink the size of the AI model, it does not affect its operation. This is similar in behavior to file compression and allows for faster operation on the target device. At 1070, the AI model is trained and ready for use in portable locator 20.

The foregoing description of the invention has been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. A portable device for use in conjunction with a transmitter that is moved through the ground at a jobsite while transmitting at one or more frequencies, the jobsite including electromagnetic noise that can vary across the jobsite and within a transmission frequency range associated with the transmitter, said portable device comprising:
a noise detector for receiving electromagnetic noise data at the jobsite in an absence of transmission of the one or more frequencies from the transmitter; and
a processing arrangement configured for
(i) capturing the electromagnetic noise data from the noise detector to form a noise dataset that characterizes the electromagnetic noise data such that the noise dataset increases in size with ongoing capture of the electromagnetic noise data,
(ii) responsive to ending the capture of the noise dataset such that the noise dataset covers a fixed time duration, preprocessing the captured electromagnetic noise data to represent the captured electromagnetic noise data as an image that conforms to a set of predetermined input requirements of a frequency selection Artificial Intelligence (AI) model, and
(iii) analyzing the image using the frequency selection AI model that is trained on a plurality of datasets of historical noise data to select the one or more frequencies within the transmission frequency range for subsequent use by the transmitter during an inground operation.

2. The portable device of claim 1 wherein the processing arrangement is configured for storing the noise dataset in an image format.

3. The portable device of claim 1 wherein the processing arrangement is configured for storing the noise dataset as a spectrogram.

4. The portable device of claim 1 wherein the electromagnetic noise data characterizes a spectrogram.

5. The portable device of claim 4 wherein the spectrogram at least represents time on a first axis and the electromagnetic noise data on a second axis that is orthogonal to the first axis.

6. The portable device of claim 5 wherein the electromagnetic noise data is represented on the second axis such that a plurality of noise values are assigned in an overall frequency range from a lowest frequency to a highest frequency.

7. The portable device of claim 5 wherein the first axis at least indexes a time of collection of the electromagnetic noise data against a frequency content of the electromagnetic noise data at the time of collection.

8. The portable device of claim 7 further comprising:
a GPS receiver that outputs a GPS position; and
the processing arrangement is configured to additionally index the electromagnetic noise data against the GPS position corresponding to the time of collection of the electromagnetic noise data on the first axis.

9. The portable device of claim 5 wherein the second axis extends from 1 kHz or lower at least up to 50 KHz.

10. The portable device of claim 9 wherein the second axis extends down to a powerline frequency.

11. The portable device of claim 1 wherein the processing arrangement captures the electromagnetic noise data by (i) successively measuring the electromagnetic noise in a series of time increments such that a set of noise data corresponds to each time increment and (ii) appends each set of noise data to the noise dataset.

12. The portable device of claim 11 wherein the time increments include a duration that is based on a predicted minimum noise feature duration.

13. The portable device of claim 11 wherein the time increment is no more than one second.

14. The portable device of claim 1 wherein the electromagnetic noise data is represented by the noise dataset such that individual noise values are assigned at a frequency increment that is based on a transmission frequency resolution of the transmitter.

15. The portable device of claim 1 wherein the electromagnetic noise data is represented by the noise dataset such that individual noise values are assigned at a frequency increment that is at least 5 Hz.

16. The portable device of claim 1 wherein the noise detector includes a triaxial antenna for receiving the electromagnetic noise data on three individual axes and the processing arrangement configures the noise dataset as a grid such that any given location in the grid individually records a noise value for each individual axis.

17. The portable device of claim 1 wherein the noise detector includes a triaxial antenna for receiving the electromagnetic noise data on three individual axes and the processing arrangement configures the noise dataset as a grid such that any given location in the grid records a noise value derived from the three individual axes as a magnitude.

18. The portable device of claim 1 wherein the processing arrangement is further configured to weight the electromagnetic noise data to compensate for at least one of depth, location and duration of the electromagnetic noise.

19. The portable device of claim 1 wherein the frequency selection AI model is trained to compensate for at least one of a transmitter frequency response and desired depth specified by a user or by a bore plan.

20. The portable device of claim 1 wherein preprocessing includes at least one of cropping the image and resizing the image to conform to the set of predetermined input requirements of the AI model.

21. The portable device of claim 1 wherein the noise dataset characterizes an unmodified grid of original noise readings recorded in a plurality of noise positions along one axis indexed against a plurality of time positions along an orthogonal axis and the predetermined input requirements require a predetermined grid of a predetermined number of noise positions arranged against a predetermined number of time positions and the processing arrangement is configured for fitting the unmodified grid to the predetermined grid.

22. The portable device of claim 21 wherein the predetermined number of time positions is less than a total number of the plurality of time positions in the unmodified grid and the processing arrangement is configured to fit the unmodified grid to the predetermined grid by averaging a plurality of the original noise readings for any given position in the predetermined grid to conform to the predetermined input requirements.

23. The portable device of claim 21 wherein the processing arrangement is configured to store the noise dataset to match the predetermined number of noise positions in the predetermined grid.

24. The portable device of claim 21 wherein the predetermined number of noise positions is greater than a total number of the plurality of noise positions and the processing arrangement is configured to fit the unmodified grid to the predetermined grid by expanding the plurality of original noise readings to fill the predetermined number of noise positions to conform to the predetermined input requirements.

25. The portable device of claim 1 wherein the processing arrangement includes a region identification AI model that is trained on a plurality of data sets of region specific historical noise data configured to identify two or more regions in the noise dataset, the regions occurring at least in consecutive, non-overlapping periods of time and each of which regions exhibits a common noise feature that is not shared with any adjacent one of the regions and the frequency selection AI model is configured to select a transmission frequency for each region.

26. A method for operating a portable device for use in conjunction with a transmitter that is moved through the ground at a jobsite while transmitting at one or more selectable frequencies, the jobsite including electromagnetic noise that can vary across the jobsite and within a transmission frequency range associated with the transmitter, said method comprising:
(i) capturing electromagnetic noise data as measured by the portable device at the jobsite in an absence of transmission of the one or more selectable frequencies from the transmitter to form a noise dataset such that the noise dataset increases in size with ongoing capture of the electromagnetic noise data;
(ii) responsive to ending the capture of the noise dataset such that the noise dataset covers a fixed time duration, preprocessing the captured electromagnetic noise data to represent the captured electromagnetic noise data as an image that conforms to a set of predetermined input requirements of a frequency selection Artificial Intelligence (AI) model, and
(iii) analyzing the image using the frequency selection AI model that is trained on a plurality of data sets of historical noise data to select the one or more frequencies within the transmission frequency range for subsequent use by the transmitter during an inground operation.

27. A portable device for use in conjunction with a transmitter that is moved through the ground at a jobsite while transmitting at one or more frequencies, the jobsite including electromagnetic noise that can vary across the jobsite and within a transmission frequency range associated with the transmitter, said portable device comprising:
a noise detector for receiving electromagnetic noise data at the jobsite in an absence of transmission of the one or more frequencies from the transmitter; and
a processing arrangement configured for
(i) capturing the electromagnetic noise data from the noise detector as a series of data segments such that each data segment conforms to a set of predetermined input requirements of a frequency selection Artificial Intelligence (AI) model,
(ii) analyzing each data segment using the frequency selection AI model that is trained on a plurality of data sets of historical noise data to determine a preliminary selection of the one or more frequencies within the transmission frequency range for each data segment such that a series of preliminary selections of the one or more frequencies corresponds to the series of data segments, and
(iii) based on the series of preliminary selections of the one or more frequencies, finalizing the one or more frequencies for transmission by the transmitter during an inground operation.

28. The portable device of claim 27 wherein said processing arrangement is configured to finalize the one or more frequencies by applying rankings to the one or more frequencies on a per segment basis and comparing the rankings to determine finalized frequency selections.

29. The portable device of claim 27 wherein said processing arrangement is configured to discard any final data segment at a conclusion of capturing the electromagnetic noise data that does not conform to a predetermined time dimension as part of the set of predetermined input requirements.

30. A portable device for use in conjunction with a transmitter that is moved through the ground at a jobsite while transmitting at one or more frequencies, the jobsite including electromagnetic noise that can vary across the jobsite and within a transmission frequency range associated with the transmitter, said portable device comprising:
a noise detector for receiving electromagnetic noise data at the jobsite in an absence of transmission of the one or more frequencies from the transmitter; and
a processing arrangement configured for
(i) capturing the electromagnetic noise data from the noise detector to form a noise dataset that characterizes the electromagnetic noise data such that the noise dataset increases in size with ongoing capture of the electromagnetic noise data,
(ii) responsive to ending the capture of the noise dataset such that the noise dataset covers a fixed time duration, preprocessing the captured electromagnetic noise data to represent the captured electromagnetic noise data as a predicted depth map that conforms to a set of predetermined input requirements of a frequency selection Artificial Intelligence (AI) model;
(iii) analyzing the predicted depth map using a frequency selection AI model that is trained on a plurality of data sets of historical predicted depth data to select the one or more frequencies within the transmission frequency range for subsequent use by the transmitter during an inground operation.

31. The portable device of claim 30 wherein the processing arrangement is configured, as part of said preprocessing, to convert the electromagnetic noise data to predicted depth data.

32. A portable device for use in conjunction with a transmitter that is moved through the ground at a jobsite while transmitting at one or more frequencies, the jobsite including electromagnetic noise that can vary across the jobsite and within a transmission frequency range associated with the transmitter, said portable device comprising:
a noise detector for receiving original electromagnetic noise data at the jobsite in an absence of transmission of the one or more selectable frequencies from the transmitter; and
a processing arrangement configured for
(i) capturing the electromagnetic noise data from the noise detector to form a noise dataset that characterizes the electromagnetic noise data such that the noise dataset increases in size with ongoing capture of the electromagnetic noise data,
(ii) responsive to ending the capture of the noise dataset such that the noise dataset covers a fixed time duration, preprocessing the captured electromagnetic noise data to represent the captured electromagnetic noise data as an image that conforms to a set of predetermined input requirements of a frequency band selection Artificial Intelligence (AI) model, and
(iii) analyzing the image using the frequency band selection AI model that is trained on a plurality of data sets of historical noise data to select at least one or more low noise bands within the transmission frequency range for subsequent use by the transmitter to transmit the one or more frequencies within the one or more selected low noise bands during an inground operation.

33. The portable device of claim 32 wherein the electromagnetic noise data is represented such that individual noise values are assigned at a frequency increment that is based on a transmission frequency resolution of the transmitter.

34. The portable device of claim 32 wherein the electromagnetic noise data is represented such that individual noise values are assigned at a frequency increment that is at least 5 Hz.

35. The portable device of claim 32 wherein the noise dataset characterizes one or more spectrograms that at least represent time on a first axis and the electromagnetic noise data on a second axis that is orthogonal to the first axis.

36. The portable device of claim 35 wherein the electromagnetic noise data is represented on the second axis such that a plurality of noise values are assigned in an overall frequency range from a lowest frequency to a highest frequency.

37. The portable device of claim 35 wherein the first axis at least indexes a time of collection of the electromagnetic noise data against a frequency content of the electromagnetic noise data at the time of collection.

38. The portable device of claim 37 further comprising a GPS receiver and wherein the processing arrangement additionally indexes the electromagnetic noise data against a GPS position corresponding to the time of collection of the electromagnetic noise data on the first axis.

39. The portable device of claim 33 wherein the second axis extends from 1 kHz or lower at least up to 50 KHz.

40. The portable device of claim 33 wherein the second axis extends down to a powerline frequency.

41. The portable device of claim 33 wherein the electromagnetic noise data is represented on the second axis such that noise values are assigned within a plurality of bands that increase in frequency from one band to the next and from which the one or more low noise bands are selected.

42. The portable device of claim 41, wherein the one or more AI models determine a per band score for each one of the bands to rank the bands relative to one another based on the original electromagnetic noise data for selecting the one or more low noise bands.

43. The portable device of claim 32 wherein the processing arrangement captures the electromagnetic noise data by (i) successively measuring the electromagnetic noise in a series of time increments such that a set of noise data corresponds to each time increment and (ii) appending each set of noise data to the noise dataset.

44. The portable device of claim 32 wherein the noise detector includes a triaxial antenna for receiving the electromagnetic noise data on three individual axes and configures the noise dataset as a grid such that any given location in the grid individually records a noise value for each individual axis.

45. The portable device of claim 32 wherein the noise detector includes a triaxial antenna for receiving the electromagnetic noise data on three individual axes and the processing arrangement configures the noise dataset as a grid such that any given location in the grid records a noise value derived from the three individual axes as a magnitude.

46. The portable device of claim 32 wherein the processing arrangement includes a first AI model for analyzing a rebar frequency range to select a rebar low noise band within the rebar frequency range and a second AI model for analyzing a standard frequency range extending from a lower frequency limit that is above the rebar frequency range to an upper frequency limit and which standard frequency range is made up of a set of standard frequency bands that increase in frequency from one standard frequency band to the next to select at least one low noise standard frequency band within the standard frequency range.

47. The portable device of claim 46 wherein the processing arrangement is configured for running the first AI model in parallel with the second AI model.

48. The portable device of claim 46 wherein the processing arrangement is configured for preprocessing by cropping the standard frequency range from the noise dataset to produce a rebar dedicated noise dataset and for resizing the rebar dedicated noise dataset to conform to the set of predetermined input requirements prior to analyzing by the first AI model.

49. The portable device of claim 48 wherein preprocessing further includes cropping the rebar frequency range from the noise dataset to produce a standard frequency dedicated noise dataset and resizing the standard frequency dedicated noise dataset to conform to the set of predetermined input requirements prior to said analyzing by the second AI model.

50. The portable device of claim 32 wherein the one or more AI models are trained to compensate for at least one of active interference, location dependent noise and passive interference.

51. The portable device of claim 32 wherein the preprocessing includes at least one of cropping the image and resizing the image to conform to the set of predetermined input requirement.

52. The portable device of claim 32 wherein the processing arrangement includes a region identification AI model that is trained on a plurality of data sets of region specific historical noise data configured to identify two or more regions in the noise dataset, the regions occurring at least in consecutive, non-overlapping periods of time and each of which regions exhibits a common noise feature in the noise dataset that is not shared with any adjacent one of the regions and the one or more AI models are configured to select a low noise band for each region.

53. The portable device of claim 52 wherein the electromagnetic noise data is represented such that noise values are assigned within a plurality of bands that increase in frequency from one band to the next and the processing arrangement is configured to apply the one or more AI models to determine a per band score for each one of the bands in each one of the regions to rank the bands relative to one another in each region based on the original electromagnetic noise data.

54. The portable device of claim 53 wherein the processing arrangement is configured to apply a time-based weighting to the per band scores of each region based on a time of duration of each region such that a relatively higher time of duration results in a relatively higher time-based weighted band score to provide a set of time-based weighted band scores for each region and assigning a particular band corresponding to a highest time-based weighted band score for any given region as a time-based region-preferred band for the given region.

55. The portable device of claim 53 wherein the regions further occur in consecutive, non-overlapping lengthwise distances along an intended path and the processing arrangement is configured to apply a distance weighting to the per band scores of each region based on a length of each region along the intended path such that a relatively greater length results in a relatively higher distance-based weighted band score to provide a set of distance-based weighted band scores for each region and assigning a particular band corresponding to a highest distance-based weighted band score for any given region as a distance-based region-preferred band for the given region.

56. The portable device of claim 53 wherein the transmitter is configured for transmission in a particular number of modes, with each mode corresponding to one of the bands and a total number of the regions is greater than the particular number of modes and said processing arrangement is configured for (i) applying one of a time-based weighting and a distance-based weighting to the per band scores to produce a set of weighted band scores for each region, (ii) determining a region-independent overall band score for each band as a total of the weighted band scores for any given band across all of the regions, (iii) matching the number of selected low noise bands to the number of modes based on the region-independent overall band scores, and (iv) assigning one of the selected low noise bands to each region.

57. A portable device for use in conjunction with a transmitter that is moved through the ground at a jobsite while transmitting at one or more selectable frequencies, the jobsite including electromagnetic noise that can vary across the jobsite and within a transmission frequency range associated with the transmitter, the portable device comprising:
a noise detector for receiving electromagnetic noise data at the jobsite in an absence of transmission of the one or more selectable frequencies from the transmitter; and
a processing arrangement configured for
(i) capturing the electromagnetic noise data from the noise detector to form a noise dataset that characterizes the electromagnetic noise data such that the noise dataset increases in size with ongoing capture of the electromagnetic noise data;
(ii) responsive to ending the capture of the noise dataset such that the noise dataset covers a fixed time duration, preprocessing the captured electromagnetic noise data to represent the captured electromagnetic noise data as an image that conforms to a set of predetermined input requirements of a region identification Artificial Intelligence (AI) model, and
(iii) analyzing the image using the region identification AI model that is trained on a plurality of data sets of region specific historical electromagnetic noise data to identify a first border between an initial, first region of the electromagnetic noise data and a remaining portion of the electromagnetic noise data such that the first region exhibits a common noise feature that is not shared with at least an initial part of the remaining portion of the electromagnetic noise data and the first region corresponds to a first portion of the electromagnetic noise data.

58. The portable device of claim 57 wherein the processing arrangement is further configured for:
(a) creating a modified image that excludes the electromagnetic noise data corresponding to the first region and thereby represents the electromagnetic noise data corresponding to the remaining portion of the electromagnetic noise data; and
(b) analyzing the modified image using the region identification AI model to identify an additional border serving to define at least the start of an additional region in the modified image that exhibits another common noise feature that is not shared with the first region.

59. The portable device of claim 58 wherein said processing arrangement is further configured for repeating (a)-(b) by creating an additional modified image that excludes the original electromagnetic noise all previously identified regions, and analyzing the additional modified image to identify another border.

60. The portable device of claim 57 wherein the processing arrangement is configured to create a region specific image of corresponding electromagnetic noise data for each identified region and preprocess each region specific image to conform to a framework of predetermined input requirements of one or more low noise frequency band identification Artificial Intelligence (AI) models that are trained on a plurality of data sets of historical electromagnetic noise data to select at least one or more low noise frequencies within the identified regions.
